(19) United States
(12) Patent Application Publication
(10) Pub. No.: US 2018/0373413 A1
(43) Pub. Date: Dec. 27, 2018

(54) INFORMATION PROCESSING METHOD AND APPARATUS, AND PROGRAM FOR EXECUTING THE INFORMATION PROCESSING METHOD ON COMPUTER

(71) Applicant: COLOPL, Inc., Tokyo (JP)

(72) Inventor: Kazuaki SAWAKI, Tokyo (JP)

(21) Appl. No.: 15/983,229

(22) Filed: May 18, 2018

(30) Foreign Application Priority Data
May 19, 2017 (JP) 2017-099895

(51) Int. Cl. G06F 3/0481; H04N 5/232; G06F 3/16; H04N 13/373; H04N 13/376; H04N 13/378; H04N 13/332

(52) U.S. Cl. CPC G06F 3/04815; H04N 5/23245; H04N 5/23216; H04N 13/332; H04N 13/373; H04N 13/376; H04N 13/378; G06F 3/167

(57) ABSTRACT

A method includes defining a virtual space. The virtual space includes a virtual viewpoint, a reference position, a first character object associated with a first user, and a second character object associated with a second user. The method further includes defining a movement pattern of the reference position in the virtual space and a photography mode, wherein the photography mode includes a mode selected by the first user from among a plurality of modes. The method further includes storing video data captured from the reference position in accordance with the photography mode, wherein the video data defines an omnidirectional moving image in a predetermined photographing period. The method further includes reproducing the stored video data in the virtual space.

### RELATED APPLICATIONS

The present application claims priority to Japanese Application No. 2017-099895, filed on May 19, 2017, the disclosure of which is hereby incorporated by reference herein in its entirety.

### TECHNICAL FIELD

This disclosure relates to an information processing method and an apparatus for executing the information processing method.

### BACKGROUND

In Non-Patent Document 1, there is described a technology for moving an avatar object associated with a user in a virtual space based on an operation by the user.

### [Non-Patent Documents]

[Non-Patent Document 1] “Facebook Mark Zuckerberg Social VR Demo 0C3 Oculus Connect 3 Keynote”, [online], Oct. 6, 2016, VRvibe, [retrieved on Dec. 5, 2016], Internet <https : //www.youtube.com/watch?v=NCpNKLXovtE>

### [Patent Documents]

[Patent Document 1] U.S. Pat. No. 9,573,062 B1

### SUMMARY

According to at least one embodiment of this disclosure, there is provided a method including defining a virtual space, the virtual space including a virtual viewpoint, a reference position, a first character object associated with a first user, and a second character object associated with a second user. The method further includes detecting a motion of a user terminal including a display. The method further includes defining a visual field in the virtual space in accordance with a position of the virtual viewpoint in the virtual space and the motion of the user terminal. The method further includes generating a visual-field image corresponding to the visual field. The method further includes displaying the visual-field image on the display. The method further includes causing the first character object to speak based on a sound input by the first user. The method further includes causing the second character object to speak based on a sound input by the second user; identifying, of the first character object and the second character object, a character object of interest having a larger quantity of utterances. The method further includes defining a movement pattern of the reference position in the virtual space and a photography mode, the photography mode being a mode selected by the first user from among a plurality of modes prepared in advance. The method further includes storing video data in accordance with the photography mode, the video data defining an omnidirectional moving image, which is a video in all directions from the reference position in a predetermined photographing period, the photography mode defining the movement pattern such that the character object of interest is preferentially shown. In some embodiments, the photography mode is an image capturing mode configured to capture a still image or a moving image.

### [BRIEF DESCRIPTION OF THE DRAWINGS]

FIG. 1 A diagram of a system including a head-mounted device (HMD) according to at least one embodiment of this disclosure.

FIG. 2 A block diagram of a hardware configuration of a computer according to at least one embodiment of this disclosure.

FIG. 3 A diagram of a uvw visual-field coordinate system to be set for an HMD according to at least one embodiment of this disclosure.

FIG. 4 A diagram of a mode of expressing a virtual space according to at least one embodiment of this disclosure.

FIG. 5 A diagram of a plan view of a head of a user wearing the HMD according to at least one embodiment of this disclosure.

FIG. 6 A diagram of a YZ cross section obtained by viewing a field-of-view region from an X direction in the virtual space according to at least one embodiment of this disclosure.

FIG. 7 A diagram of an XZ cross section obtained by viewing the field-of-view region from a Y direction in the virtual space according to at least one embodiment of this disclosure.

FIG. 8A A diagram of a schematic configuration of a controller according to at least one embodiment of this disclosure.

FIG. 8B A diagram of a coordinate system to be set for a hand of a user holding the controller according to at least one embodiment of this disclosure.

FIG. 9 A block diagram of a hardware configuration of a server according to at least one embodiment of this disclosure.

FIG. 10 A block diagram of a computer according to at least one embodiment of this disclosure.

FIG. 11 A sequence chart of processing to be executed by a system including an HMD set according to at least one embodiment of this disclosure.

FIG. 12A A schematic diagram of HMD systems of several users sharing the virtual space interact using a network according to at least one embodiment of this disclosure.

FIG. 12B A diagram of a field of view image of a HMD according to at least one embodiment of this disclosure.

FIG. 13 A sequence diagram of processing to be executed by a system including an HMD interacting in a network according to at least one embodiment of this disclosure.

FIG. 14 A block diagram of modules of the computer according to at least one embodiment of this disclosure.

FIG. 15 A flowchart of processing to be executed according to at least one embodiment of this disclosure.

FIG. 16 A schematic diagram of a virtual space shared by a plurality of users according to at least one embodiment of this disclosure.

FIG. 17 A diagram of a field-of-view image to be provided to a user according to at least one embodiment of this disclosure.

FIG. 18 A flowchart of processing relating to storage and playback of recording data according to at least one embodiment of this disclosure.

FIG. 19 A flowchart of a processing relating to storage and playback of recording data according to at least one embodiment of this disclosure.

FIG. 20 A diagram of a reference position according to at least one embodiment of this disclosure.

FIG. 21 A diagram of motion information according to at least one embodiment of this disclosure.

FIG. 22 A flowchart of processing relating to storage and playback of recording data according to at least one embodiment of this disclosure.

FIG. 23 A flowchart of processing relating to extraction of a display object according to at least one embodiment of this disclosure.

FIG. 24 A diagram of a display object according to at least one embodiment of this disclosure.

FIG. 25A A diagram of a display object according to at least one embodiment of this disclosure.

FIG. 25B A diagram of a display object according to at least one embodiment of this disclosure.

### DETAILED DESCRIPTION

Now, with reference to the drawings, embodiments of this technical idea are described in detail. In the following description, like components are denoted by like reference symbols. The same applies to the names and functions of those components. Therefore, detailed description of those components is not repeated. In one or more embodiments described in this disclosure, components of respective embodiments can be combined with each other, and the combination also serves as a part of the embodiments described in this disclosure.

### [Configuration of HMD System]

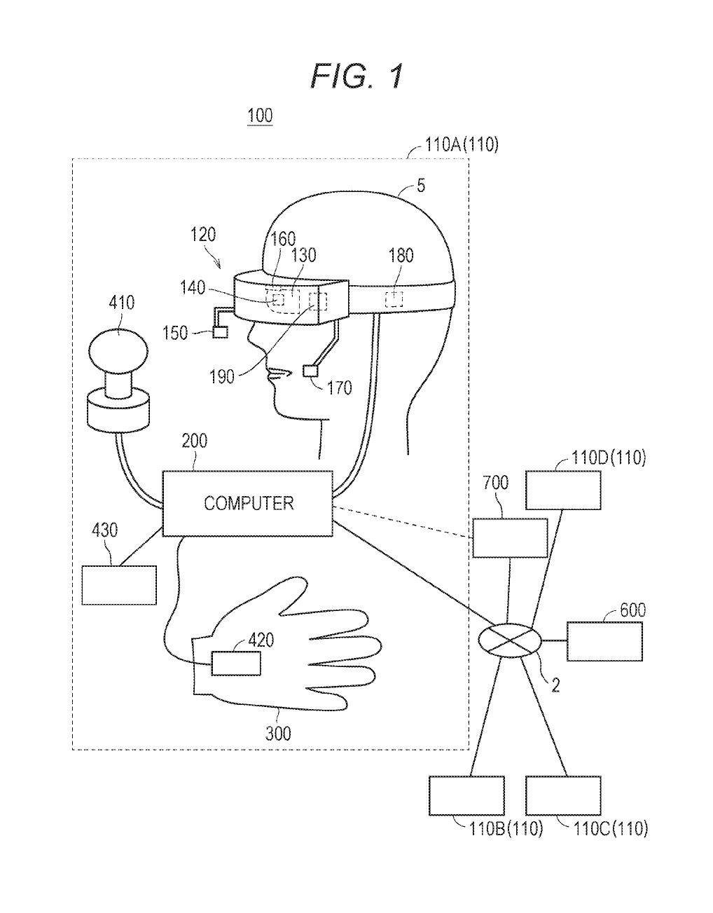

With reference to FIG. 1, a configuration of a head-mounted device (HMD) system 100 is described. FIG. 1 is a diagram of a system 100 including a head-mounted display (HMD) according to at least one embodiment of this disclosure. The system 100 is usable for household use or for professional use.

The system 100 includes a server 600, HMD sets 110A, 110B, 110C, and 110D, an external device 700, and a network 2. Each of the HMD sets 110A, 110B, 110C, and 110D is capable of independently communicating to/from the server 600 or the external device 700 via the network 2. In some instances, the HMD sets 110A, 110B, 110C, and 110D are also collectively referred to as “HMD set 110”. The number of HMD sets 110 constructing the HMD system 100 is not limited to four, but may be three or less, or five or more. The HMD set 110 includes an HMD 120, a computer 200, an HMD sensor 410, a display 430, and a controller 300. The HMD 120 includes a monitor 130, an eye gaze sensor 140, a first camera 150, a second camera 160, a microphone 170, and a speaker 180. In at least one embodiment, the controller 300 includes a motion sensor 420.

In at least one aspect, the computer 200 is connected to the network 2, for example, the Internet, and is able to communicate to/from the server 600 or other computers connected to the network 2 in a wired or wireless manner. Examples of the other computers include a computer of another HMD set 110 or the external device 700. In at least one aspect, the HMD 120 includes a sensor 190 instead of the HMD sensor 410. In at least one aspect, the HMD 120 includes both sensor 190 and the HMD sensor 410.

The HMD 120 is wearable on a head of a user 5 to display a virtual space to the user 5 during operation. More specifically, in at least one embodiment, the HMD 120 displays each of a right-eye image and a left-eye image on the monitor 130. Each eye of the user 5 is able to visually recognize a corresponding image from the right-eye image and the left-eye image so that the user 5 may recognize a three-dimensional image based on the parallax of both of the user's the eyes. In at least one embodiment, the HMD 120 includes any one of a so-called head-mounted display including a monitor or a head-mounted device capable of mounting a smartphone or other terminals including a monitor.

The monitor 130 is implemented as, for example, a non-transmissive display device. In at least one aspect, the monitor 130 is arranged on a main body of the HMD 120 so as to be positioned in front of both the eyes of the user 5. Therefore, when the user 5 is able to visually recognize the three-dimensional image displayed by the monitor 130, the user 5 is immersed in the virtual space. In at least one aspect, the virtual space includes, for example, a background, objects that are operable by the user 5, or menu images that are selectable by the user 5. In at least one aspect, the monitor 130 is implemented as a liquid crystal monitor or an organic electroluminescence (EL) monitor included in a so-called smartphone or other information display terminals.

In at least one aspect, the monitor 130 is implemented as a transmissive display device. In this case, the user 5 is able to see through the HMD 120 covering the eyes of the user 5, for example, smartglasses. In at least one embodiment, the transmissive monitor 130 is configured as a temporarily non-transmissive display device through adjustment of a transmittance thereof. In at least one embodiment, the monitor 130 is configured to display a real space and a part of an image constructing the virtual space simultaneously. For example, in at least one embodiment, the monitor 130 displays an image of the real space captured by a camera mounted on the HMD 120, or may enable recognition of the real space by setting the transmittance of a part the monitor 130 sufficiently high to permit the user 5 to see through the HMD 120.

In at least one aspect, the monitor 130 includes a sub-monitor for displaying a right-eye image and a sub-monitor for displaying a left-eye image. In at least one aspect, the monitor 130 is configured to integrally display the right-eye image and the left-eye image. In this case, the monitor 130 includes a high-speed shutter. The high-speed shutter operates so as to alternately display the right-eye image to the right of the user 5 and the left-eye image to the left eye of the user 5, so that only one of the user's 5 eyes is able to recognize the image at any single point in time.

In at least one aspect, the HMD 120 includes a plurality of light sources (not shown). Each light source is implemented by, for example, a light emitting diode (LED) configured to emit an infrared ray. The HMD sensor 410 has a position tracking function for detecting the motion of the HMD 120. More specifically, the HMD sensor 410 reads a plurality of infrared rays emitted by the HMD 120 to detect the position and the inclination of the HMD 120 in the real space.

In at least one aspect, the HMD sensor 410 is implemented by a camera. In at least one aspect, the HMD sensor 410 uses image information of the HMD 120 output from the camera to execute image analysis processing, to thereby enable detection of the position and the inclination of the HMD 120.

In at least one aspect, the HMD 120 includes the sensor 190 instead of, or in addition to, the HMD sensor 410 as a position detector. In at least one aspect, the HMD 120 uses the sensor 190 to detect the position and the inclination of the HMD 120. For example, in at least one embodiment, when the sensor 190 is an angular velocity sensor, a geomagnetic sensor, or an acceleration sensor, the HMD 120 uses any or all of those sensors instead of (or in addition to) the HMD sensor 410 to detect the position and the inclination of the HMD 120. As an example, when the sensor 190 is an angular velocity sensor, the angular velocity sensor detects over time the angular velocity about each of three axes of the HMD 120 in the real space. The HMD 120 calculates a temporal change of the angle about each of the three axes of the HMD 120 based on each angular velocity, and further calculates an inclination of the HMD 120 based on the temporal change of the angles.

The eye gaze sensor 140 detects a direction in which the lines of sight of the right eye and the left eye of the user 5 are directed. That is, the eye gaze sensor 140 detects the line of sight of the user 5. The direction of the line of sight is detected by, for example, a known eye tracking function. The eye gaze sensor 140 is implemented by a sensor having the eye tracking function. In at least one aspect, the eye gaze sensor 140 includes a right-eye sensor and a left-eye sensor. In at least one embodiment, the eye gaze sensor 140 is, for example, a sensor configured to irradiate the right eye and the left eye of the user 5 with an infrared ray, and to receive reflection light from the cornea and the iris with respect to the irradiation light, to thereby detect a rotational angle of each of the user's 5 eyeballs. In at least one embodiment, the eye gaze sensor 140 detects the line of sight of the user 5 based on each detected rotational angle.

The first camera 150 photographs a lower part of a face of the user 5. More specifically, the first camera 150 photographs, for example, the nose or mouth of the user 5. The second camera 160 photographs, for example, the eyes and eyebrows of the user 5. A side of a casing of the HMD 120 on the user 5 side is defined as an interior side of the HMD 120, and a side of the casing of the HMD 120 on a side opposite to the user 5 side is defined as an exterior side of the HMD 120. In at least one aspect, the first camera 150 is arranged on an exterior side of the HMD 120, and the second camera 160 is arranged on an interior side of the HMD 120. Images generated by the first camera 150 and the second camera 160 are input to the computer 200. In at least one aspect, the first camera 150 and the second camera 160 are implemented as a single camera, and the face of the user 5 is photographed with this single camera.

The microphone 170 converts an utterance of the user 5 into a voice signal (electric signal) for output to the computer 200. The speaker 180 converts the voice signal into a voice for output to the user 5. In at least one embodiment, the speaker 180 converts other signals into audio information provided to the user 5. In at least one aspect, the HMD 120 includes earphones in place of the speaker 180.

The controller 300 is connected to the computer 200 through wired or wireless communication. The controller 300 receives input of a command from the user 5 to the computer 200. In at least one aspect, the controller 300 is held by the user 5. In at least one aspect, the controller 300 is mountable to the body or a part of the clothes of the user 5. In at least one aspect, the controller 300 is configured to output at least anyone of a vibration, a sound, or light based on the signal transmitted from the computer 200. In at least one aspect, the controller 300 receives from the user 5 an operation for controlling the position and the motion of an object arranged in the virtual space.

In at least one aspect, the controller 300 includes a plurality of light sources. Each light source is implemented by, for example, an LED configured to emit an infrared ray. The HMD sensor 410 has a position tracking function. In this case, the HMD sensor 410 reads a plurality of infrared rays emitted by the controller 300 to detect the position and the inclination of the controller 300 in the real space. In at least one aspect, the HMD sensor 410 is implemented by a camera. In this case, the HMD sensor 410 uses image information of the controller 300 output from the camera to execute image analysis processing, to thereby enable detection of the position and the inclination of the controller 300.

In at least one aspect, the motion sensor 420 is mountable on the hand of the user 5 to detect the motion of the hand of the user 5. For example, the motion sensor 420 detects a rotational speed, a rotation angle, and the number of rotations of the hand. The detected signal is transmitted to the computer 200. The motion sensor 420 is provided to, for example, the controller 300. In at least one aspect, the motion sensor 420 is provided to, for example, the controller 300 capable of being held by the user 5. In at least one aspect, to help prevent accidently release of the controller 300 in the real space, the controller 300 is mountable on an object like a glove-type object that does not easily fly away by being worn on a hand of the user 5. In at least one aspect, a sensor that is not mountable on the user 5 detects the motion of the hand of the user 5. For example, a signal of a camera that photographs the user 5 may be input to the computer 200 as a signal representing the motion of the user 5. As at least one example, the motion sensor 420 and the computer 200 are connected to each other through wired or wireless communication. In the case of wireless communication, the communication mode is not particularly limited, and for example, Bluetooth (trademark) or other known communication methods are usable.

The display 430 displays an image similar to an image displayed on the monitor 130. With this, a user other than the user 5 wearing the HMD 120 can also view an image similar to that of the user 5. An image to be displayed on the display 430 is not required to be a three-dimensional image, but may be a right-eye image or a left-eye image. For example, a liquid crystal display or an organic EL monitor may be used as the display 430.

In at least one embodiment, the server 600 transmits a program to the computer 200. In at least one aspect, the server 600 communicates to/from another computer 200 for providing virtual reality to the HMD 120 used by another user. For example, when a plurality of users play a participatory game, for example, in an amusement facility, each computer 200 communicates to/from another computer 200 via the server 600 with a signal that is based on the motion of each user, to thereby enable the plurality of users to enjoy a common game in the same virtual space. Each computer 200 may communicate to/from another computer 200 with the signal that is based on the motion of each user without intervention of the server 600.

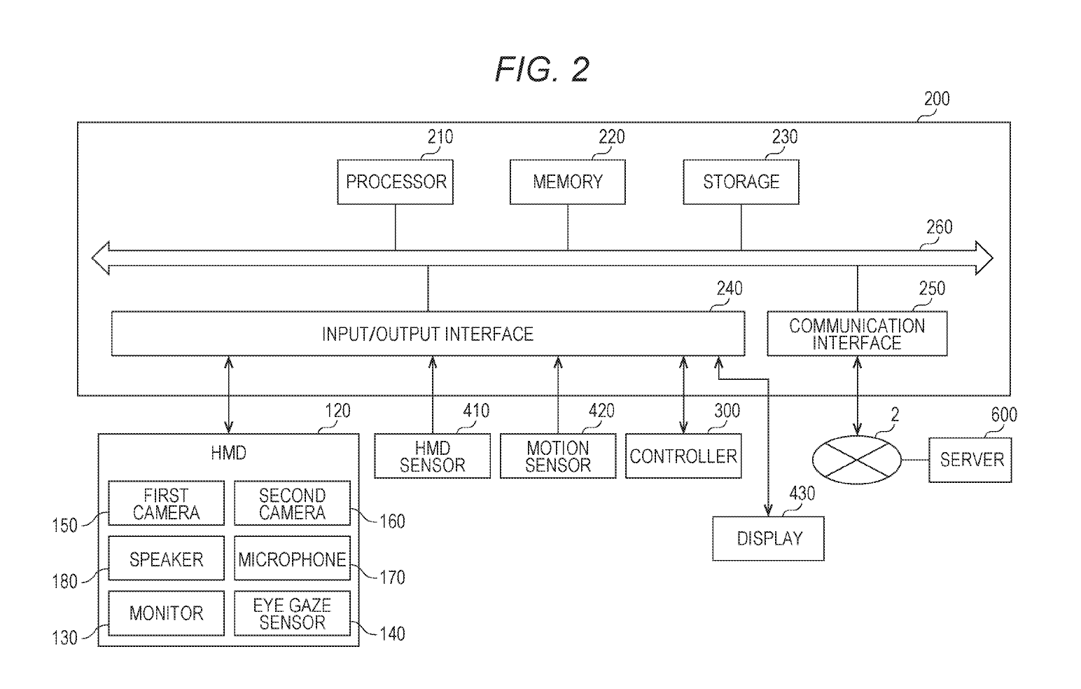

The external device 700 is any suitable device as long as the external device 700 is capable of communicating to/from the computer 200. The external device 700 is, for example, a device capable of communicating to/from the computer 200 via the network 2, or is a device capable of directly communicating to/from the computer 200 by near field communication or wired communication. Peripheral devices such as a smart device, a personal computer (PC), or the computer 200 are usable as the external device 700, in at least one embodiment, but the external device 700 is not limited thereto.

[Hardware Configuration of Computer]With reference to FIG. 2, the computer 200 in at least one embodiment is described. FIG. 2 is a block diagram of a hardware configuration of the computer 200 according to at least one embodiment. The computer 200 includes, a processor 210, a memory 220, a storage 230, an input/output interface 240, and a communication interface 250. Each component is connected to a bus 260. In at least one embodiment, at least one of the processor 210, the memory 220, the storage 230, the input/output interface 240 or the communication interface 250 is part of a separate structure and communicates with other components of computer 200 through a communication path other than the bus 260.

The processor 210 executes a series of commands included in a program stored in the memory 220 or the storage 230 based on a signal transmitted to the computer 200 or in response to a condition determined in advance. In at least one aspect, the processor 210 is implemented as a central processing unit (CPU), a graphics processing unit (GPU), a micro-processor unit (MPU), a field-programmable gate array (FPGA), or other devices.

The memory 220 temporarily stores programs and data. The programs are loaded from, for example, the storage 230. The data includes data input to the computer 200 and data generated by the processor 210. In at least one aspect, the memory 220 is implemented as a random access memory (RAM) or other volatile memories.

The storage 230 permanently stores programs and data. In at least one embodiment, the storage 230 stores programs and data for a period of time longer than the memory 220, but not permanently. The storage 230 is implemented as, for example, a read-only memory (ROM), a hard disk device, a flash memory, or other non-volatile storage devices. The programs stored in the storage 230 include programs for providing a virtual space in the system 100, simulation programs, game programs, user authentication programs, and programs for implementing communication to/from other computers 200. The data stored in the storage 230 includes data and objects for defining the virtual space.

In at least one aspect, the storage 230 is implemented as a removable storage device like a memory card. In at least one aspect, a configuration that uses programs and data stored in an external storage device is used instead of the storage 230 built into the computer 200. With such a configuration, for example, in a situation in which a plurality of HMD systems 100 are used, for example in an amusement facility, the programs and the data are collectively updated.

The input/output interface 240 allows communication of signals among the HMD 120, the HMD sensor 410, the motion sensor 420, and the display 430. The monitor 130, the eye gaze sensor 140, the first camera 150, the second camera 160, the microphone 170, and the speaker 180 included in the HMD 120 may communicate to/from the computer 200 via the input/output interface 240 of the HMD 120. In at least one aspect, the input/output interface 240 is implemented with use of a universal serial bus (USB), a digital visual interface (DVI), a high-definition multimedia interface (HDMI) (trademark), or other terminals. The input/output interface 240 is not limited to the specific examples described above.

In at least one aspect, the input/output interface 240 further communicates to/from the controller 300. For example, the input/output interface 240 receives input of a signal output from the controller 300 and the motion sensor 420. In at least one aspect, the input/output interface 240 transmits a command output from the processor 210 to the controller 300. The command instructs the controller 300 to, for example, vibrate, output a sound, or emit light. When the controller 300 receives the command, the controller 300 executes any one of vibration, sound output, and light emission in accordance with the command.

The communication interface 250 is connected to the network 2 to communicate to/from other computers (e.g., server 600) connected to the network 2. In at least one aspect, the communication interface 250 is implemented as, for example, a local area network (LAN), other wired communication interfaces, wireless fidelity (Wi-Fi), Bluetooth (R), near field communication (NFC), or other wireless communication interfaces. The communication interface 250 is not limited to the specific examples described above.

In at least one aspect, the processor 210 accesses the storage 230 and loads one or more programs stored in the storage 230 to the memory 220 to execute a series of commands included in the program. In at least one embodiment, the one or more programs includes an operating system of the computer 200, an application program for providing a virtual space, and/or game software that is executable in the virtual space. The processor 210 transmits a signal for providing a virtual space to the HMD 120 via the input/output interface 240. The HMD 120 displays a video on the monitor 130 based on the signal.

In FIG. 2, the computer 200 is outside of the HMD 120, but in at least one aspect, the computer 200 is integral with the HMD 120. As an example, a portable information communication terminal (e.g., smartphone) including the monitor 130 functions as the computer 200 in at least one embodiment.

In at least one embodiment, the computer 200 is used in common with a plurality of HMDs 120. With such a configuration, for example, the computer 200 is able to provide the same virtual space to a plurality of users, and hence each user can enjoy the same application with other users in the same virtual space.

According to at least one embodiment of this disclosure, in the system 100, a real coordinate system is set in advance. The real coordinate system is a coordinate system in the real space. The real coordinate system has three reference directions (axes) that are respectively parallel to a vertical direction, a horizontal direction orthogonal to the vertical direction, and a front-rear direction orthogonal to both of the vertical direction and the horizontal direction in the real space. The horizontal direction, the vertical direction (up-down direction), and the front-rear direction in the real coordinate system are defined as an x axis, a y axis, and a z axis, respectively. More specifically, the x axis of the real coordinate system is parallel to the horizontal direction of the real space, the y axis thereof is parallel to the vertical direction of the real space, and the z axis thereof is parallel to the front-rear direction of the real space.

In at least one aspect, the HMD sensor 410 includes an infrared sensor. When the infrared sensor detects the infrared ray emitted from each light source of the HMD 120, the infrared sensor detects the presence of the HMD 120. The HMD sensor 410 further detects the position and the inclination (direction) of the HMD 120 in the real space, which corresponds to the motion of the user 5 wearing the HMD 120, based on the value of each point (each coordinate value in the real coordinate system). In more detail, the HMD sensor 410 is able to detect the temporal change of the position and the inclination of the HMD 120 with use of each value detected over time.

Each inclination of the HMD 120 detected by the HMD sensor 410 corresponds to an inclination about each of the three axes of the HMD 120 in the real coordinate system. The HMD sensor 410 sets a uvw visual-field coordinate system to the HMD 120 based on the inclination of the HMD 120 in the real coordinate system. The uvw visual-field coordinate system set to the HMD 120 corresponds to a point-of-view coordinate system used when the user 5 wearing the HMD 120 views an object in the virtual space.

### [Uvw Visual-field Coordinate System]

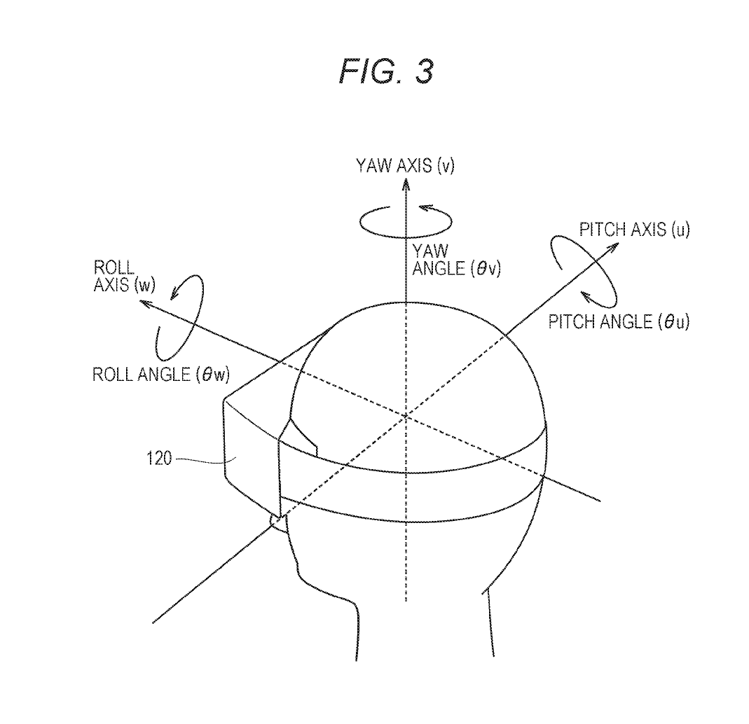

With reference to FIG. 3, the uvw visual-field coordinate system is described. FIG. 3 is a diagram of a uvw visual-field coordinate system to be set for the HMD 120 according to at least one embodiment of this disclosure. The HMD sensor 410 detects the position and the inclination of the HMD 120 in the real coordinate system when the HMD 120 is activated. The processor 210 sets the uvw visual-field coordinate system to the HMD 120 based on the detected values.

In FIG. 3, the HMD 120 sets the three-dimensional uvw visual-field coordinate system defining the head of the user 5 wearing the HMD 120 as a center (origin). More specifically, the HMD 120 sets three directions newly obtained by inclining the horizontal direction, the vertical direction, and the front-rear direction (x axis, y axis, and z axis), which define the real coordinate system, about the respective axes by the inclinations about the respective axes of the HMD 120 in the real coordinate system, as a pitch axis (u axis), a yaw axis (v axis), and a roll axis (w axis) of the uvw visual-field coordinate system in the HMD 120.

In at least one aspect, when the user 5 wearing the HMD 120 is standing (or sitting) upright and is visually recognizing the front side, the processor 210 sets the uvw visual-field coordinate system that is parallel to the real coordinate system to the HMD 120. In this case, the horizontal direction (x axis), the vertical direction (y axis), and the front-rear direction (z axis) of the real coordinate system directly match the pitch axis (u axis), the yaw axis (v axis), and the roll axis (w axis) of the uvw visual-field coordinate system in the HMD 120, respectively.

After the uvw visual-field coordinate system is set to the HMD 120, the HMD sensor 410 is able to detect the inclination of the HMD 120 in the set uvw visual-field coordinate system based on the motion of the HMD 120. In this case, the HMD sensor 410 detects, as the inclination of the HMD 120, each of a pitch angle (θu), a yaw angle (θv), and a roll angle (θw) of the HMD 120 in the uvw visual-field coordinate system. The pitch angle (θu) represents an inclination angle of the HMD 120 about the pitch axis in the uvw visual-field coordinate system. The yaw angle (θv) represents an inclination angle of the HMD 120 about the yaw axis in the uvw visual-field coordinate system. The roll angle (θw) represents an inclination angle of the HMD 120 about the roll axis in the uvw visual-field coordinate system.

The HMD sensor 410 sets, to the HMD 120, the uvw visual-field coordinate system of the HMD 120 obtained after the movement of the HMD 120 based on the detected inclination angle of the HMD 120. The relationship between the HMD 120 and the uvw visual-field coordinate system of the HMD 120 is constant regardless of the position and the inclination of the HMD 120. When the position and the inclination of the HMD 120 change, the position and the inclination of the uvw visual-field coordinate system of the HMD 120 in the real coordinate system change in synchronization with the change of the position and the inclination.

In at least one aspect, the HMD sensor 410 identifies the position of the HMD 120 in the real space as a position relative to the HMD sensor 410 based on the light intensity of the infrared ray or a relative positional relationship between a plurality of points (e.g., distance between points), which is acquired based on output from the infrared sensor. In at least one aspect, the processor 210 determines the origin of the uvw visual-field coordinate system of the HMD 120 in the real space (real coordinate system) based on the identified relative position.

### [Virtual Space]

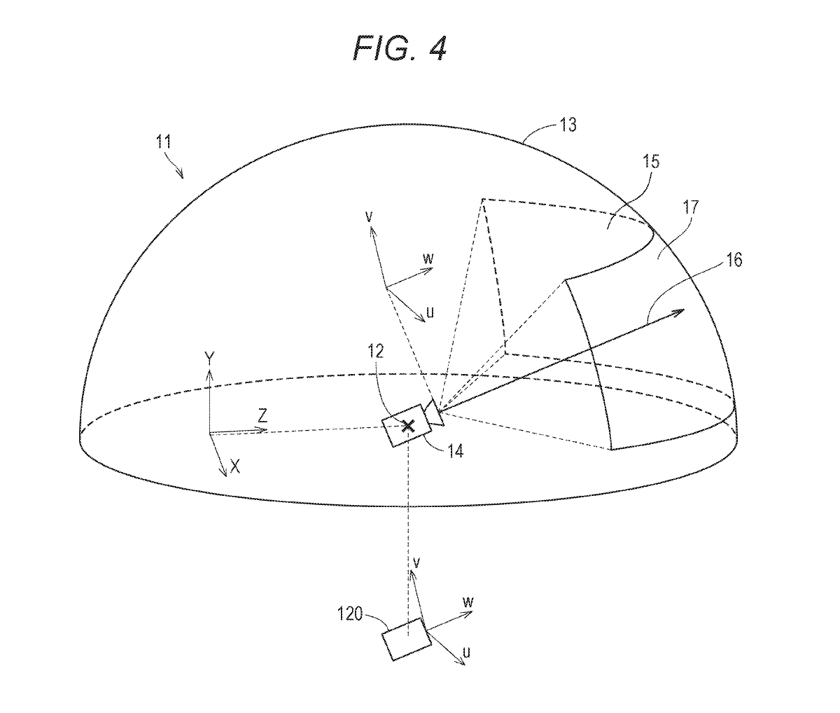

With reference to FIG. 4, the virtual space is further described. FIG. 4 is a diagram of a mode of expressing a virtual space 11 according to at least one embodiment of this disclosure. The virtual space 11 has a structure with an entire celestial sphere shape covering a center 12 in all 360-degree directions. In FIG. 4, for the sake of clarity, only the upper-half celestial sphere of the virtual space 11 is included. Each mesh section is defined in the virtual space 11. The position of each mesh section is defined in advance as coordinate values in an XYZ coordinate system, which is a global coordinate system defined in the virtual space 11. The computer 200 associates each partial image forming a panorama image 13 (e.g., still image or moving image) that is developed in the virtual space 11 with each corresponding mesh section in the virtual space 11.

In at least one aspect, in the virtual space 11, the XYZ coordinate system having the center 12 as the origin is defined. The XYZ coordinate system is, for example, parallel to the real coordinate system. The horizontal direction, the vertical direction (up-down direction), and the front-rear direction of the XYZ coordinate system are defined as an X axis, a Y axis, and a Z axis, respectively. Thus, the X axis (horizontal direction) of the XYZ coordinate system is parallel to the x axis of the real coordinate system, the Y axis (vertical direction) of the XYZ coordinate system is parallel to the y axis of the real coordinate system, and the Z axis (front-rear direction) of the XYZ coordinate system is parallel to the z axis of the real coordinate system.

When the HMD 120 is activated, that is, when the HMD 120 is in an initial state, a virtual camera 14 is arranged at the center 12 of the virtual space 11. In at least one embodiment, the virtual camera 14 is offset from the center 12 in the initial state. In at least one aspect, the processor 210 displays on the monitor 130 of the HMD 120 an image photographed by the virtual camera 14. In synchronization with the motion of the HMD 120 in the real space, the virtual camera 14 similarly moves in the virtual space 11. With this, the change in position and direction of the HMD 120 in the real space is reproduced similarly in the virtual space 11.

The uvw visual-field coordinate system is defined in the virtual camera 14 similarly to the case of the HMD 120. The uvw visual-field coordinate system of the virtual camera 14 in the virtual space 11 is defined to be synchronized with the uvw visual-field coordinate system of the HMD 120 in the real space (real coordinate system). Therefore, when the inclination of the HMD 120 changes, the inclination of the virtual camera 14 also changes in synchronization therewith. The virtual camera 14 can also move in the virtual space 11 in synchronization with the movement of the user 5 wearing the HMD 120 in the real space.

The processor 210 of the computer 200 defines a field-of-view region 15 in the virtual space 11 based on the position and inclination (reference line of sight 16) of the virtual camera 14. The field-of-view region 15 corresponds to, of the virtual space 11, the region that is visually recognized by the user 5 wearing the HMD 120. That is, the position of the virtual camera 14 determines a point of view of the user 5 in the virtual space 11.

The line of sight of the user 5 detected by the eye gaze sensor 140 is a direction in the point-of-view coordinate system obtained when the user 5 visually recognizes an object. The uvw visual-field coordinate system of the HMD 120 is equal to the point-of-view coordinate system used when the user 5 visually recognizes the monitor 130. The uvw visual-field coordinate system of the virtual camera 14 is synchronized with the uvw visual-field coordinate system of the HMD 120. Therefore, in the system 100 in at least one aspect, the line of sight of the user 5 detected by the eye gaze sensor 140 can be regarded as the line of sight of the user 5 in the uvw visual-field coordinate system of the virtual camera 14.

### [User's Line of Sight]

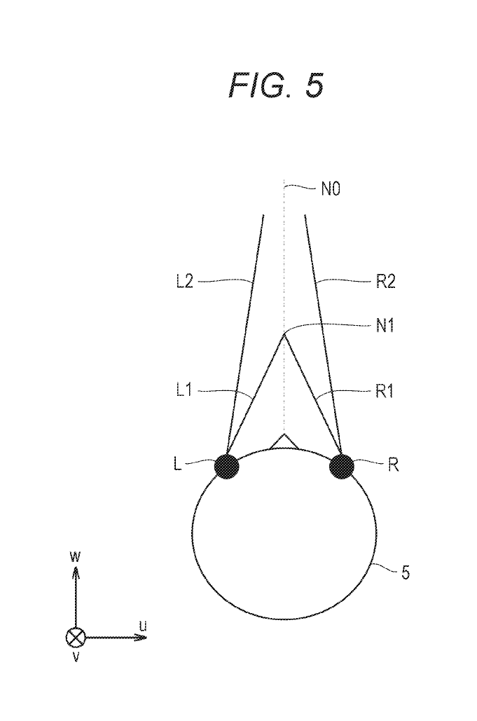

With reference to FIG. 5, determination of the line of sight of the user 5 is described. FIG. 5 is a plan view diagram of the head of the user 5 wearing the HMD 120 according to at least one embodiment of this disclosure.

In at least one aspect, the eye gaze sensor 140 detects lines of sight of the right eye and the left eye of the user 5. In at least one aspect, when the user 5 is looking at a near place, the eye gaze sensor 140 detects lines of sight R1 and L1. In at least one aspect, when the user 5 is looking at a far place, the eye gaze sensor 140 detects lines of sight R2 and L2. In this case, the angles formed by the lines of sight R2 and L2 with respect to the roll axis w are smaller than the angles formed by the lines of sight R1 and L1 with respect to the roll axis w. The eye gaze sensor 140 transmits the detection results to the computer 200.

When the computer 200 receives the detection values of the lines of sight R1 and L1 from the eye gaze sensor 140 as the detection results of the lines of sight, the computer 200 identifies a point of gaze N1 being an intersection of both the lines of sight R1 and L1 based on the detection values. Meanwhile, when the computer 200 receives the detection values of the lines of sight R2 and L2 from the eye gaze sensor 140, the computer 200 identifies an intersection of both the lines of sight R2 and L2 as the point of gaze. The computer 200 identifies a line of sight N0 of the user 5 based on the identified point of gaze N1. The computer 200 detects, for example, an extension direction of a straight line that passes through the point of gaze N1 and a midpoint of a straight line connecting a right eye R and a left eye L of the user 5 to each other as the line of sight N0. The line of sight NO is a direction in which the user 5 actually directs his or her lines of sight with both eyes. The line of sight NO corresponds to a direction in which the user 5 actually directs his or her lines of sight with respect to the field-of-view region 15.

In at least one aspect, the system 100 includes a television broadcast reception tuner. With such a configuration, the system 100 is able to display a television program in the virtual space 11.

In at least one aspect, the HMD system 100 includes a communication circuit for connecting to the Internet or has a verbal communication function for connecting to a telephone line or a cellular service.

[Field-of-view Region]

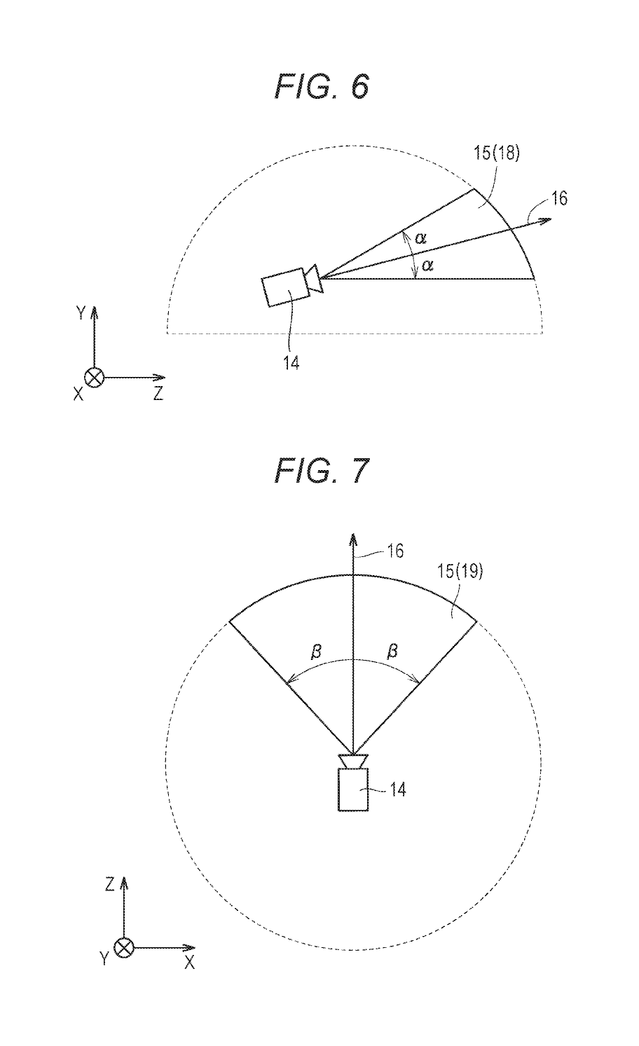

With reference to FIG. 6 and FIG. 7, the field-of-view region 15 is described. FIG. 6 is a diagram of a YZ cross section obtained by viewing the field-of-view region 15 from an X direction in the virtual space 11. FIG. 7 is a diagram of an XZ cross section obtained by viewing the field-of-view region 15 from a Y direction in the virtual space 11.

In FIG. 6, the field-of-view region 15 in the YZ cross section includes a region 18. The region 18 is defined by the position of the virtual camera 14, the reference line of sight 16, and the YZ cross section of the virtual space 11. The processor 210 defines a range of a polar angle α from the reference line of sight 16 serving as the center in the virtual space as the region 18.

In FIG. 7, the field-of-view region 15 in the XZ cross section includes a region 19. The region 19 is defined by the position of the virtual camera 14, the reference line of sight 16, and the XZ cross section of the virtual space 11. The processor 210 defines a range of an azimuth β from the reference line of sight 16 serving as the center in the virtual space 11 as the region 19. The polar angle α and β are determined in accordance with the position of the virtual camera 14 and the inclination (direction) of the virtual camera 14.

In at least one aspect, the system 100 causes the monitor 130 to display a field-of-view image 17 based on the signal from the computer 200, to thereby provide the field of view in the virtual space 11 to the user 5. The field-of-view image 17 corresponds to a part of the panorama image 13, which corresponds to the field-of-view region 15. When the user 5 moves the HMD 120 worn on his or her head, the virtual camera 14 is also moved in synchronization with the movement. As a result, the position of the field-of-view region 15 in the virtual space 11 is changed. With this, the field-of-view image 17 displayed on the monitor 130 is updated to an image of the panorama image 13, which is superimposed on the field-of-view region 15 synchronized with a direction in which the user 5 faces in the virtual space 11. The user 5 can visually recognize a desired direction in the virtual space 11.

In this way, the inclination of the virtual camera 14 corresponds to the line of sight of the user 5 (reference line of sight 16) in the virtual space 11, and the position at which the virtual camera 14 is arranged corresponds to the point of view of the user 5 in the virtual space 11. Therefore, through the change of the position or inclination of the virtual camera 14, the image to be displayed on the monitor 130 is updated, and the field of view of the user 5 is moved.

While the user 5 is wearing the HMD 120 (having a non-transmissive monitor 130), the user 5 can visually recognize only the panorama image 13 developed in the virtual space 11 without visually recognizing the real world. Therefore, the system 100 provides a high sense of immersion in the virtual space 11 to the user 5.

In at least one aspect, the processor 210 moves the virtual camera 14 in the virtual space 11 in synchronization with the movement in the real space of the user 5 wearing the HMD 120. In this case, the processor 210 identifies an image region to be projected on the monitor 130 of the HMD 120 (field-of-view region 15) based on the position and the direction of the virtual camera 14 in the virtual space 11.

In at least one aspect, the virtual camera 14 includes two virtual cameras, that is, a virtual camera for providing a right-eye image and a virtual camera for providing a left-eye image. An appropriate parallax is set for the two virtual cameras so that the user 5 is able to recognize the three-dimensional virtual space 11. In at least one aspect, the virtual camera 14 is implemented by a single virtual camera. In this case, a right-eye image and a left-eye image may be generated from an image acquired by the single virtual camera. In at least one embodiment, the virtual camera 14 is assumed to include two virtual cameras, and the roll axes of the two virtual cameras are synthesized so that the generated roll axis (w) is adapted to the roll axis (w) of the HMD 120.

### [Controller]

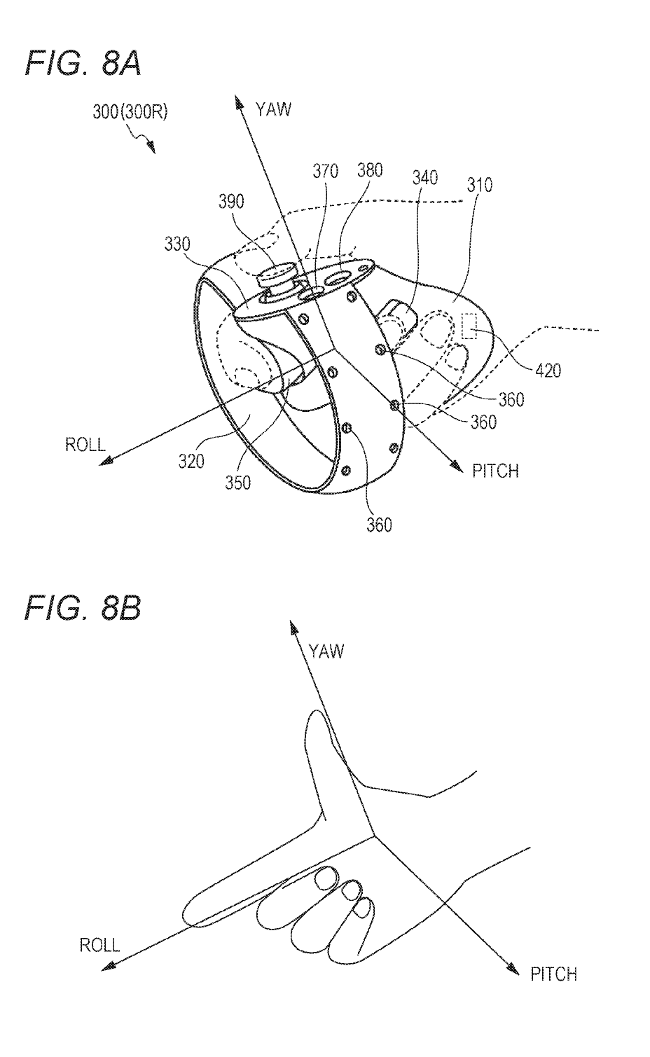

An example of the controller 300 is described with reference to FIG. 8A and FIG. 8B. FIG. 8A is a diagram of a schematic configuration of a controller according to at least one embodiment of this disclosure. FIG. 8B is a diagram of a coordinate system to be set for a hand of a user holding the controller according to at least one embodiment of this disclosure.

In at least one aspect, the controller 300 includes a right controller 300R and a left controller (not shown). In FIG. 8A only right controller 300R is shown for the sake of clarity. The right controller 300R is operable by the right hand of the user 5. The left controller is operable by the left hand of the user 5. In at least one aspect, the right controller 300R and the left controller are symmetrically configured as separate devices. Therefore, the user 5 can freely move his or her right hand holding the right controller 300R and his or her left hand holding the left controller. In at least one aspect, the controller 300 may be an integrated controller configured to receive an operation performed by both the right and left hands of the user 5. The right controller 300R is now described.

The right controller 300R includes a grip 310, a frame 320, and a top surface 330. The grip 310 is configured so as to be held by the right hand of the user 5. For example, the grip 310 may be held by the palm and three fingers (e.g., middle finger, ring finger, and small finger) of the right hand of the user 5.

The grip 310 includes buttons 340 and 350 and the motion sensor 420. The button 340 is arranged on a side surface of the grip 310, and receives an operation performed by, for example, the middle finger of the right hand. The button 350 is arranged on a front surface of the grip 310, and receives an operation performed by, for example, the index finger of the right hand. In at least one aspect, the buttons 340 and 350 are configured as trigger type buttons. The motion sensor 420 is built into the casing of the grip 310. When a motion of the user 5 can be detected from the surroundings of the user 5 by a camera or other device. In at least one embodiment, the grip 310 does not include the motion sensor 420.

The frame 320 includes a plurality of infrared LEDs 360 arranged in a circumferential direction of the frame 320. The infrared LEDs 360 emit, during execution of a program using the controller 300, infrared rays in accordance with progress of the program. The infrared rays emitted from the infrared LEDs 360 are usable to independently detect the position and the posture (inclination and direction) of each of the right controller 300R and the left controller. In FIG. 8A, the infrared LEDs 360 are shown as being arranged in two rows, but the number of arrangement rows is not limited to that illustrated in FIGS. 8. In at least one embodiment, the infrared LEDs 360 are arranged in one row or in three or more rows. In at least one embodiment, the infrared LEDs 360 are arranged in a pattern other than rows.

The top surface 330 includes buttons 370 and 380 and an analog stick 390. The buttons 370 and 380 are configured as push type buttons. The buttons 370 and 380 receive an operation performed by the thumb of the right hand of the user 5. In at least one aspect, the analog stick 390 receives an operation performed in any direction of 360 degrees from an initial position (neutral position). The operation includes, for example, an operation for moving an object arranged in the virtual space 11.

In at least one aspect, each of the right controller 300R and the left controller includes a battery for driving the infrared ray LEDs 360 and other members. The battery includes, for example, a rechargeable battery, a button battery, a dry battery, but the battery is not limited thereto. In at least one aspect, the right controller 300R and the left controller are connectable to, for example, a USB interface of the computer 200. In at least one embodiment, the right controller 300R and the left controller do not include a battery.

In FIG. 8A and FIG. 8B, for example, a yaw direction, a roll direction, and a pitch direction are defined with respect to the right hand of the user 5. A direction of an extended thumb is defined as the yaw direction, a direction of an extended index finger is defined as the roll direction, and a direction perpendicular to a plane is defined as the pitch direction.

### [Hardware Configuration of Server]

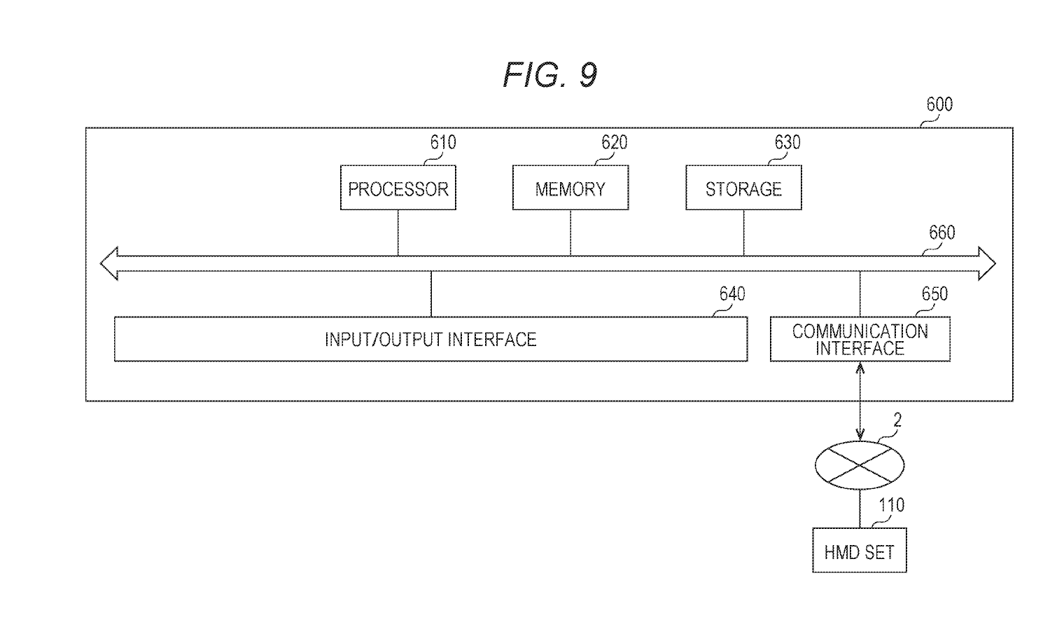

With reference to FIG. 9, the server 600 in at least one embodiment is described. FIG. 9 is a block diagram of a hardware configuration of the server 600 according to at least one embodiment of this disclosure. The server 600 includes a processor 610, a memory 620, a storage 630, an input/output interface 640, and a communication interface 650. Each component is connected to a bus 660. In at least one embodiment, at least one of the processor 610, the memory 620, the storage 630, the input/output interface 640 or the communication interface 650 is part of a separate structure and communicates with other components of server 600 through a communication path other than the bus 660.

The processor 610 executes a series of commands included in a program stored in the memory 620 or the storage 630 based on a signal transmitted to the server 600 or on satisfaction of a condition determined in advance. In at least one aspect, the processor 610 is implemented as a central processing unit (CPU), a graphics processing unit (GPU), a micro processing unit (MPU), a field-programmable gate array (FPGA), or other devices.

The memory 620 temporarily stores programs and data. The programs are loaded from, for example, the storage 630. The data includes data input to the server 600 and data generated by the processor 610. In at least one aspect, the memory 620 is implemented as a random access memory (RAM) or other volatile memories.

The storage 630 permanently stores programs and data. In at least one embodiment, the storage 630 stores programs and data for a period of time longer than the memory 620, but not permanently. The storage 630 is implemented as, for example, a read-only memory (ROM), a hard disk device, a flash memory, or other non-volatile storage devices. The programs stored in the storage 630 include programs for providing a virtual space in the system 100, simulation programs, game programs, user authentication programs, and programs for implementing communication to/from other computers 200 or servers 600. The data stored in the storage 630 may include, for example, data and objects for defining the virtual space.

In at least one aspect, the storage 630 is implemented as a removable storage device like a memory card. In at least one aspect, a configuration that uses programs and data stored in an external storage device is used instead of the storage 630 built into the server 600. With such a configuration, for example, in a situation in which a plurality of HMD systems 100 are used, for example, as in an amusement facility, the programs and the data are collectively updated.

The input/output interface 640 allows communication of signals to/from an input/output device. In at least one aspect, the input/output interface 640 is implemented with use of a USB, a DVI, an HDMI, or other terminals. The input/output interface 640 is not limited to the specific examples described above.

The communication interface 650 is connected to the network 2 to communicate to/from the computer 200 connected to the network 2. In at least one aspect, the communication interface 650 is implemented as, for example, a LAN, other wired communication interfaces, Wi-Fi, Bluetooth, NFC, or other wireless communication interfaces. The communication interface 650 is not limited to the specific examples described above.

In at least one aspect, the processor 610 accesses the storage 630 and loads one or more programs stored in the storage 630 to the memory 620 to execute a series of commands included in the program. In at least one embodiment, the one or more programs include, for example, an operating system of the server 600, an application program for providing a virtual space, and game software that can be executed in the virtual space. In at least one embodiment, the processor 610 transmits a signal for providing a virtual space to the HMD device 110 to the computer 200 via the input/output interface 640.

### [Control Device of HMD]

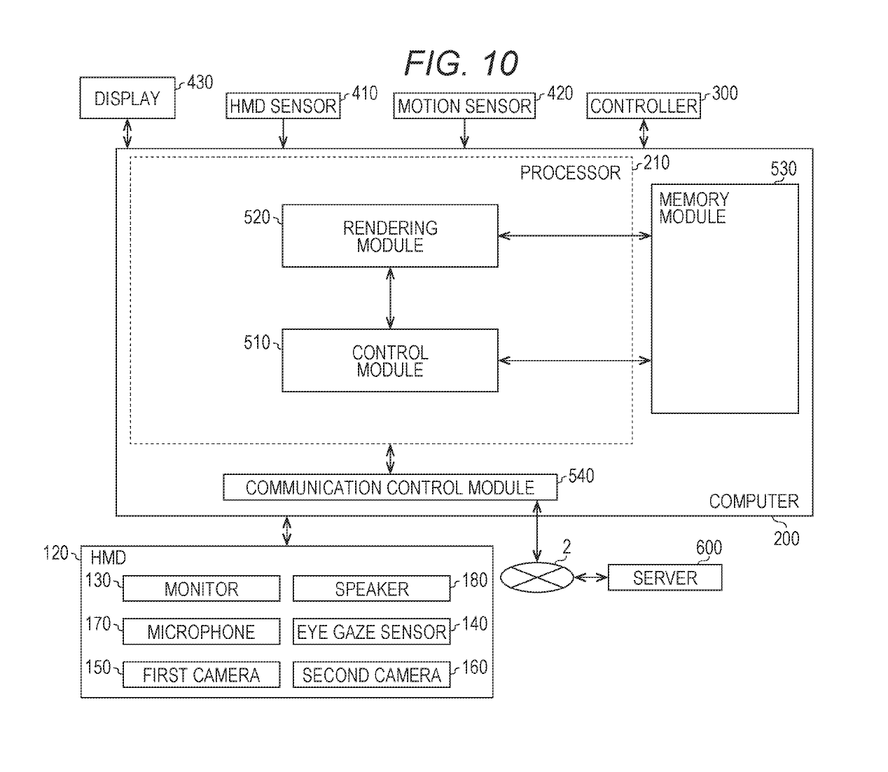

With reference to FIG. 10, the control device of the HMD 120 is described. According to at least one embodiment of this disclosure, the control device is implemented by the computer 200 having a known configuration. FIG. 10 is a block diagram of the computer 200 according to at least one embodiment of this disclosure. FIG. 10 includes a module configuration of the computer 200.

In FIG. 10, the computer 200 includes a control module 510, a rendering module 520, a memory module 530, and a communication control module 540. In at least one aspect, the control module 510 and the rendering module 520 are implemented by the processor 210. In at least one aspect, a plurality of processors 210 function as the control module 510 and the rendering module 520. The memory module 530 is implemented by the memory 220 or the storage 230. The communication control module 540 is implemented by the communication interface 250.

The control module 510 controls the virtual space 11 provided to the user 5. The control module 510 defines the virtual space 11 in the HMD system 100 using virtual space data representing the virtual space 11. The virtual space data is stored in, for example, the memory module 530. In at least one embodiment, the control module 510 generates virtual space data. In at least one embodiment, the control module 510 acquires virtual space data from, for example, the server 600.

The control module 510 arranges objects in the virtual space 11 using object data representing objects. The object data is stored in, for example, the memory module 530. In at least one embodiment, the control module 510 generates virtual space data. In at least one embodiment, the control module 510 acquires virtual space data from, for example, the server 600. In at least one embodiment, the objects include, for example, an avatar object of the user 5, character objects, operation objects, for example, a virtual hand to be operated by the controller 300, and forests, mountains, other landscapes, streetscapes, or animals to be arranged in accordance with the progression of the story of the game.

The control module 510 arranges an avatar object of the user 5 of another computer 200, which is connected via the network 2, in the virtual space 11. In at least one aspect, the control module 510 arranges an avatar object of the user 5 in the virtual space 11. In at least one aspect, the control module 510 arranges an avatar object simulating the user 5 in the virtual space 11 based on an image including the user 5. In at least one aspect, the control module 510 arranges an avatar object in the virtual space 11, which is selected by the user 5 from among a plurality of types of avatar objects (e.g., objects simulating animals or objects of deformed humans).

The control module 510 identifies an inclination of the HMD 120 based on output of the HMD sensor 410. In at least one aspect, the control module 510 identifies an inclination of the HMD 120 based on output of the sensor 190 functioning as a motion sensor. The control module 510 detects parts (e.g., mouth, eyes, and eyebrows) forming the face of the user 5 from a face image of the user 5 generated by the first camera 150 and the second camera 160. The control module 510 detects a motion (shape) of each detected part.

The control module 510 detects a line of sight of the user 5 in the virtual space 11 based on a signal from the eye gaze sensor 140. The control module 510 detects a point-of-view position (coordinate values in the XYZ coordinate system) at which the detected line of sight of the user 5 and the celestial sphere of the virtual space 11 intersect with each other. More specifically, the control module 510 detects the point-of-view position based on the line of sight of the user 5 defined in the uvw coordinate system and the position and the inclination of the virtual camera 14. The control module 510 transmits the detected point-of-view position to the server 600. In at least one aspect, the control module 510 is configured to transmit line-of-sight information representing the line of sight of the user 5 to the server 600. In such a case, the control module 510 may calculate the point-of-view position based on the line-of-sight information received by the server 600.

The control module 510 translates a motion of the HMD 120, which is detected by the HMD sensor 410, in an avatar object. For example, the control module 510 detects inclination of the HMD 120, and arranges the avatar object in an inclined manner. The control module 510 translates the detected motion of face parts in a face of the avatar object arranged in the virtual space 11. The control module 510 receives line-of-sight information of another user 5 from the server 600, and translates the line-of-sight information in the line of sight of the avatar object of another user 5. In at least one aspect, the control module 510 translates a motion of the controller 300 in an avatar object and an operation object. In this case, the controller 300 includes, for example, a motion sensor, an acceleration sensor, or a plurality of light emitting elements (e.g., infrared LEDs) for detecting a motion of the controller 300.

The control module 510 arranges, in the virtual space 11, an operation object for receiving an operation by the user 5 in the virtual space 11. The user 5 operates the operation object to, for example, operate an object arranged in the virtual space 11. In at least one aspect, the operation object includes, for example, a hand object serving as a virtual hand corresponding to a hand of the user 5. In at least one aspect, the control module 510 moves the hand object in the virtual space 11 so that the hand object moves in association with a motion of the hand of the user 5 in the real space based on output of the motion sensor 420. In at least one aspect, the operation object may correspond to a hand part of an avatar object.

When one object arranged in the virtual space 11 collides with another object, the control module 510 detects the collision. The control module 510 is able to detect, for example, a timing at which a collision area of one object and a collision area of another object have touched with each other, and performs predetermined processing in response to the detected timing. In at least one embodiment, the control module 510 detects a timing at which an object and another object, which have been in contact with each other, have moved away from each other, and performs predetermined processing in response to the detected timing. In at least one embodiment, the control module 510 detects a state in which an object and another object are in contact with each other. For example, when an operation object touches another object, the control module 510 detects the fact that the operation object has touched the other object, and performs predetermined processing.

In at least one aspect, the control module 510 controls image display of the HMD 120 on the monitor 130. For example, the control module 510 arranges the virtual camera 14 in the virtual space 11. The control module 510 controls the position of the virtual camera 14 and the inclination (direction) of the virtual camera 14 in the virtual space 11. The control module 510 defines the field-of-view region 15 depending on an inclination of the head of the user 5 wearing the HMD 120 and the position of the virtual camera 14. The rendering module 520 generates the field-of-view region 17 to be displayed on the monitor 130 based on the determined field-of-view region 15. The communication control module 540 outputs the field-of-view region 17 generated by the rendering module 520 to the HMD 120.

The control module 510, which has detected an utterance of the user 5 using the microphone 170 from the HMD 120, identifies the computer 200 to which voice data corresponding to the utterance is to be transmitted. The voice data is transmitted to the computer 200 identified by the control module 510. The control module 510, which has received voice data from the computer 200 of another user via the network 2, outputs audio information (utterances) corresponding to the voice data from the speaker 180.

The memory module 530 holds data to be used to provide the virtual space 11 to the user 5 by the computer 200. In at least one aspect, the memory module 530 stores space information, object information, and user information.

The space information stores one or more templates defined to provide the virtual space 11.

The object information stores a plurality of panorama images 13 forming the virtual space 11 and object data for arranging objects in the virtual space 11. In at least one embodiment, the panorama image 13 contains a still image and/or a moving image. In at least one embodiment, the panorama image 13 contains an image in a non-real space and/or an image in the real space. An example of the image in a non-real space is an image generated by computer graphics.

The user information stores a user ID for identifying the user 5. The user ID is, for example, an internet protocol (IP) address or a media access control (MAC) address set to the computer 200 used by the user. In at least one aspect, the user ID is set by the user. The user information stores, for example, a program for causing the computer 200 to function as the control device of the HMD system 100.

The data and programs stored in the memory module 530 are input by the user 5 of the HMD 120. Alternatively, the processor 210 downloads the programs or data from a computer (e.g., server 600) that is managed by a business operator providing the content, and stores the downloaded programs or data in the memory module 530.

In at least one embodiment, the communication control module 540 communicates to/from the server 600 or other information communication devices via the network 2.

In at least one aspect, the control module 510 and the rendering module 520 are implemented with use of, for example, Unity (R) provided by Unity Technologies. In at least one aspect, the control module 510 and the rendering module 520 are implemented by combining the circuit elements for implementing each step of processing.

The processing performed in the computer 200 is implemented by hardware and software executed by the processor 410. In at least one embodiment, the software is stored in advance on a hard disk or other memory module 530. In at least one embodiment, the software is stored on a CD-ROM or other computer-readable non-volatile data recording media, and distributed as a program product. In at least one embodiment, the software may is provided as a program product that is downloadable by an information provider connected to the Internet or other networks. Such software is read from the data recording medium by an optical disc drive device or other data reading devices, or is downloaded from the server 600 or other computers via the communication control module 540 and then temporarily stored in a storage module. The software is read from the storage module by the processor 210, and is stored in a RAM in a format of an executable program. The processor 210 executes the program.

### [Control Structure of HMD System]

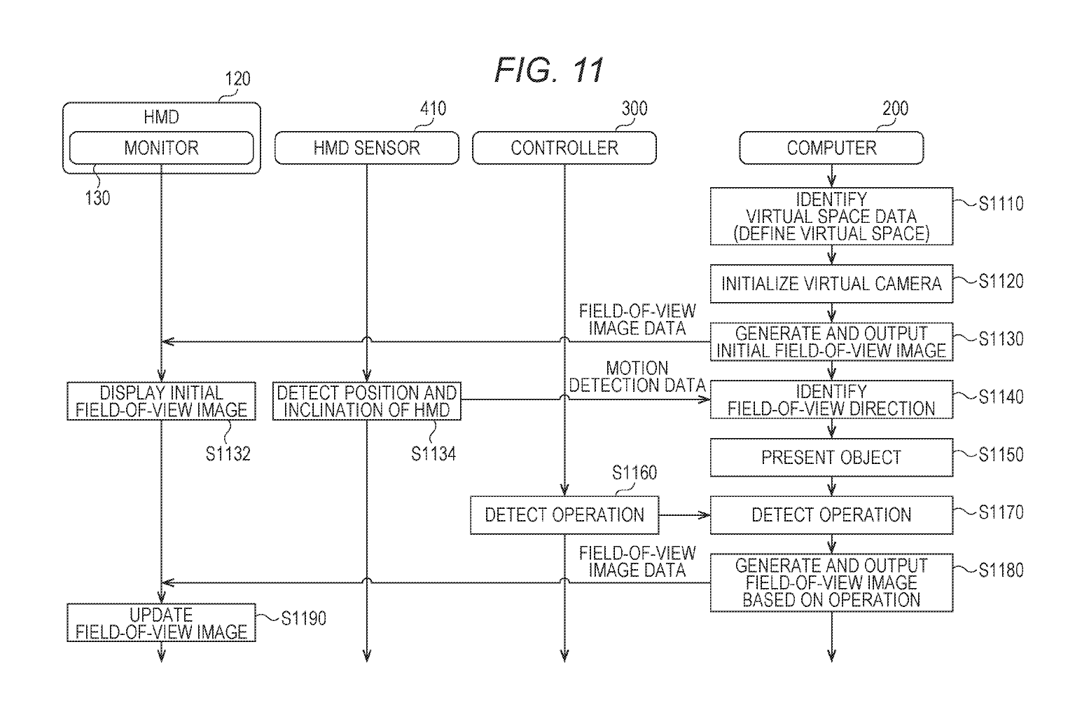

With reference to FIG. 11, the control structure of the HMD set 110 is described. FIG. 11 is a sequence chart of processing to be executed by the system 100 according to at least one embodiment of this disclosure.

In FIG. 11, in Step S1110, the processor 210 of the computer 200 serves as the control module 510 to identify virtual space data and define the virtual space 11.

In Step S1120, the processor 210 initializes the virtual camera 14. For example, in a work area of the memory, the processor 210 arranges the virtual camera 14 at the center 12 defined in advance in the virtual space 11, and matches the line of sight of the virtual camera 14 with the direction in which the user 5 faces.

In Step S1130, the processor 210 serves as the rendering module 520 to generate field-of-view image data for displaying an initial field-of-view image. The generated field-of-view image data is output to the HMD 120 by the communication control module 540.

In Step S1132, the monitor 130 of the HMD 120 displays the field-of-view image based on the field-of-view image data received from the computer 200. The user 5 wearing the HMD 120 is able to recognize the virtual space 11 through visual recognition of the field-of-view image.

In Step S1134, the HMD sensor 410 detects the position and the inclination of the HMD 120 based on a plurality of infrared rays emitted from the HMD 120. The detection results are output to the computer 200 as motion detection data.

In Step S1140, the processor 210 identifies a field-of-view direction of the user 5 wearing the HMD 120 based on the position and inclination contained in the motion detection data of the HMD 120.

In Step S1150, the processor 210 executes an application program, and arranges an object in the virtual space 11 based on a command contained in the application program.

In Step S1160, the controller 300 detects an operation by the user 5 based on a signal output from the motion sensor 420, and outputs detection data representing the detected operation to the computer 200. In at least one aspect, an operation of the controller 300 by the user 5 is detected based on an image from a camera arranged around the user 5.

In Step S1170, the processor 210 detects an operation of the controller 300 by the user 5 based on the detection data acquired from the controller 300.

In Step S1180, the processor 210 generates field-of-view image data based on the operation of the controller 300 by the user 5. The communication control module 540 outputs the generated field-of-view image data to the HMD 120.

In Step S1190, the HMD 120 updates a field-of-view image based on the received field-of-view image data, and displays the updated field-of-view image on the monitor 130.

### [Avatar Object]

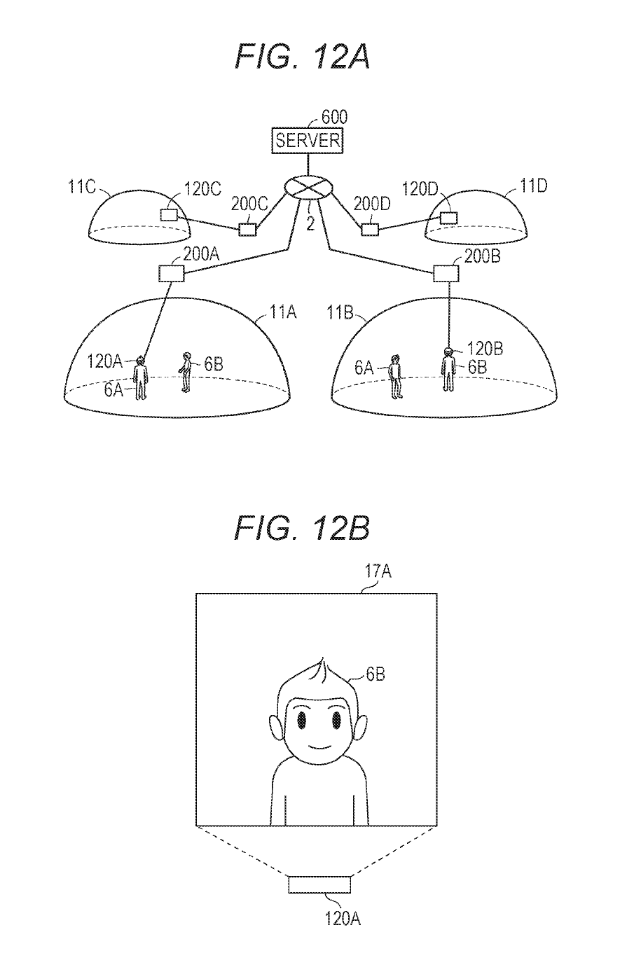

With reference to FIG. 12A and FIG. 12B, an avatar object according to at least one embodiment is described. FIG. 12 and FIG. 12B are diagrams of avatar objects of respective users 5 of the HMD sets 110A and 110B. In the following, the user of the HMD set 110A, the user of the HMD set 110B, the user of the HMD set 110C, and the user of the HMD set 110D are referred to as “user 5A”, “user 5B”, “user 5C”, and “user 5D”, respectively. A reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively. For example, the HMD 120A is included in the HMD set 110A.

FIG. 12A is a schematic diagram of HMD systems of several users sharing the virtual space interact using a network according to at least one embodiment of this disclosure. Each HMD 120 provides the user 5 with the virtual space 11. Computers 200A to 200D provide the users 5A to 5D with virtual spaces 11A to 11D via HMDs 120A to 120D, respectively. In FIG. 12A, the virtual space 11A and the virtual space 11B are formed by the same data. In other words, the computer 200A and the computer 200B share the same virtual space. An avatar object 6A of the user 5A and an avatar object 6B of the user 5B are present in the virtual space 11A and the virtual space 11B. The avatar object 6A in the virtual space 11A and the avatar object 6B in the virtual space 11B each wear the HMD 120. However, the inclusion of the HMD 120A and HMD 120B is only for the sake of simplicity of description, and the avatars do not wear the HMD 120A and HMD 120B in the virtual spaces 11A and 11B, respectively.

In at least one aspect, the processor 210A arranges a virtual camera 14A for photographing a field-of-view region 17A of the user 5A at the position of eyes of the avatar object 6A.

FIG. 12B is a diagram of a field of view of a HMD according to at least one embodiment of this disclosure. FIG. 12(B) corresponds to the field-of-view region 17A of the user 5A in FIG. 12A. The field-of-view region 17A is an image displayed on a monitor 130A of the HMD 120A. This field-of-view region 17A is an image generated by the virtual camera 14A. The avatar object 6B of the user 5B is displayed in the field-of-view region 17A. Although not included in FIG. 12B, the avatar object 6A of the user 5A is displayed in the field-of-view image of the user 5B.

In the arrangement in FIG. 12B, the user 5A can communicate to/from the user 5B via the virtual space 11A through conversation. More specifically, voices of the user 5A acquired by a microphone 170A are transmitted to the HMD 120B of the user 5B via the server 600 and output from a speaker 180B provided on the HMD 120B. Voices of the user 5B are transmitted to the HMD 120A of the user 5A via the server 600, and output from a speaker 180A provided on the HMD 120A.

The processor 210A translates an operation by the user 5B (operation of HMD 120B and operation of controller 300B) in the avatar object 6B arranged in the virtual space 11A. With this, the user 5A is able to recognize the operation by the user 5B through the avatar object 6B.

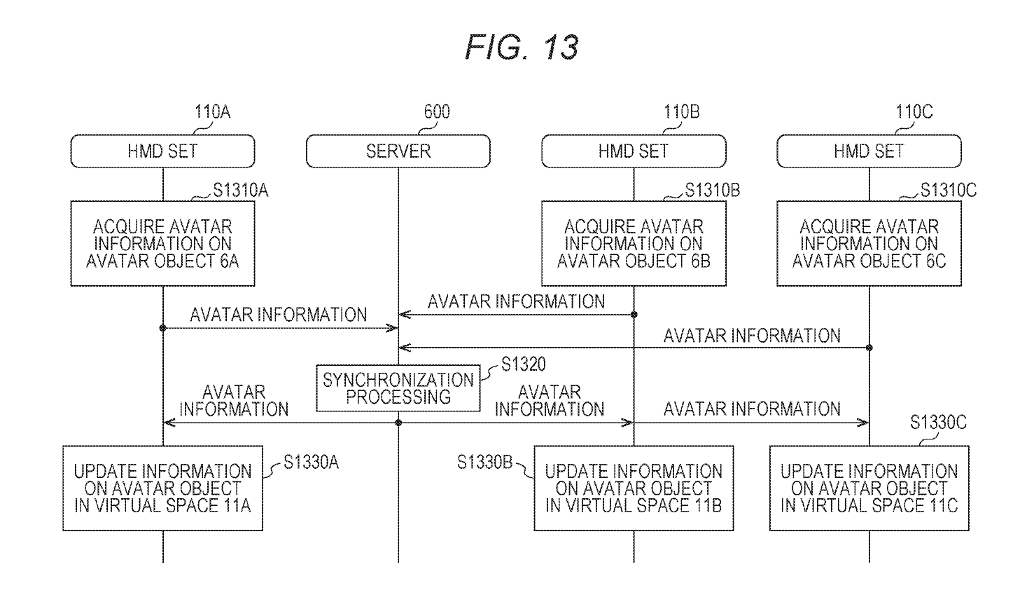

FIG. 13 is a sequence chart of processing to be executed by the system 100 according to at least one embodiment of this disclosure. In FIG. 13, although the HMD set 110D is not included, the HMD set 110D operates in a similar manner as the HMD sets 110A, 110B, and 110C. Also in the following description, a reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively.

In Step S1310A, the processor 210A of the HMD set 110A acquires avatar information for determining a motion of the avatar object 6A in the virtual space 11A. This avatar information contains information on an avatar such as motion information, face tracking data, and sound data. The motion information contains, for example, information on a temporal change in position and inclination of the HMD 120A and information on a motion of the hand of the user 5A, which is detected by, for example, a motion sensor 420A. An example of the face tracking data is data identifying the position and size of each part of the face of the user 5A. Another example of the face tracking data is data representing motions of parts forming the face of the user 5A and line-of-sight data. An example of the sound data is data representing sounds of the user 5A acquired by the microphone 170A of the HMD 120A. In at least one embodiment, the avatar information contains information identifying the avatar object 6A or the user 5A associated with the avatar object 6A or information identifying the virtual space 11A accommodating the avatar object 6A. An example of the information identifying the avatar object 6A or the user 5A is a user ID. An example of the information identifying the virtual space 11A accommodating the avatar object 6A is a room ID. The processor 210A transmits the avatar information acquired as described above to the server 600 via the network 2.

In Step S1310B, the processor 210B of the HMD set 110B acquires avatar information for determining a motion of the avatar object 6B in the virtual space 11B, and transmits the avatar information to the server 600, similarly to the processing of Step S1310A. Similarly, in Step S1310C, the processor 210C of the HMD set 110C acquires avatar information for determining a motion of the avatar object 6C in the virtual space 11C, and transmits the avatar information to the server 600.

In Step S1320, the server 600 temporarily stores pieces of player information received from the HMD set 110A, the HMD set 110B, and the HMD set 110C, respectively. The server 600 integrates pieces of avatar information of all the users (in this example, users 5A to 5C) associated with the common virtual space 11 based on, for example, the user IDs and room IDs contained in respective pieces of avatar information. Then, the server 600 transmits the integrated pieces of avatar information to all the users associated with the virtual space 11 at a timing determined in advance. In this manner, synchronization processing is executed. Such synchronization processing enables the HMD set 110A, the HMD set 110B, and the HMD 120C to share mutual avatar information at substantially the same timing.

Next, the HMD sets 110A to 110C execute processing of Step S1330A to Step S1330C, respectively, based on the integrated pieces of avatar information transmitted from the server 600 to the HMD sets 110A to 110C. The processing of Step S1330A corresponds to the processing of Step S1180 of FIG. 11.

In Step S1330A, the processor 210A of the HMD set 110A updates information on the avatar object 6B and the avatar object 6C of the other users 5B and 5C in the virtual space 11A. Specifically, the processor 210A updates, for example, the position and direction of the avatar object 6B in the virtual space 11 based on motion information contained in the avatar information transmitted from the HMD set 110B. For example, the processor 210A updates the information (e.g., position and direction) on the avatar object 6B contained in the object information stored in the memory module 530. Similarly, the processor 210A updates the information (e.g., position and direction) on the avatar object 6C in the virtual space 11 based on motion information contained in the avatar information transmitted from the HMD set 110C.

In Step S1330B, similarly to the processing of Step S1330A, the processor 210B of the HMD set 110B updates information on the avatar object 6A and the avatar object 6C of the users 5A and 5C in the virtual space 11B. Similarly, in Step S1330C, the processor 210C of the HMD set 110C updates information on the avatar object 6A and the avatar object 6B of the users 5A and 5B in the virtual space 11C.

### [Module Configuration]

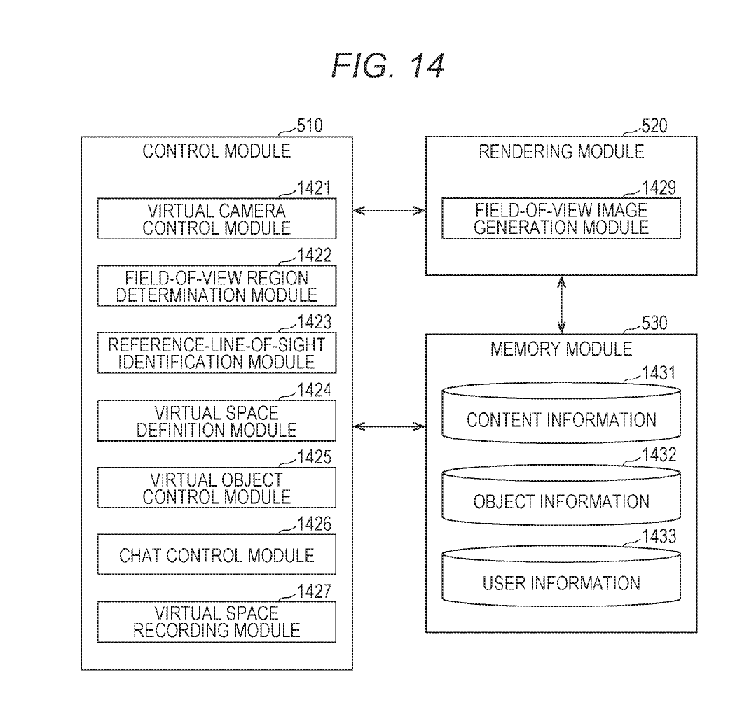

With reference to FIG. 14, a module configuration of the computer 200 are described. FIG. 14 is a block diagram of modules of the computer 200 according to at least one embodiment of this disclosure.

In FIG. 14, the control module 510 includes a virtual camera control module 1421, a field-of-view region determination module 1422, a reference-line-of-sight identification module 1423, a virtual space definition module 1424, a virtual object control module 1425, a chat control module 1426, and a virtual space recording module 1427. The rendering module 520 includes a field-of-view image generation module 1429. The memory module 530 stores content information 1431, object information 1432, and user information 1433.

In at least one aspect, the control module 510 controls display of an image on the monitor 130 of the HMD 120. The virtual camera control module 1421 arranges the virtual camera 14 in the virtual space 11, and controls, for example, the behavior and direction of the virtual camera 14. The field-of-view region determination module 1422 defines the field-of-view region 15 in accordance with the direction of the head of the user wearing the HMD 120. The field-of-view image generation module 1429 generates a field-of-view image to be displayed on the monitor 130 based on the determined field-of-view region 15. The reference-line-of-sight identification module 1423 identifies the line of sight of the user 5 based on the signal from the eye gaze sensor 140.

The control module 510 controls the virtual space 11 to be provided to the user 5. The virtual space definition module 1424 generates virtual space data representing the virtual space 11, to thereby define the virtual space 11 in the HMD set 110.

The virtual object control module 1425 generates a virtual object to be arranged in the virtual space 11 based on the content information 1431 and the object information 1432 to be described later. The virtual object control module 1425 also controls motion (e.g., movement and state change) of the virtual object in the virtual space 11.

The virtual object is any object to be arranged in the virtual space 11. The virtual object maybe, for example, an animal or scenery including forests, mountains, and the like, to be arranged in accordance with the progress of the game story. The virtual object may also be an avatar, which is an alter-ego of the user in the virtual space, or a character object such as a character (player character) in the game operated by the user. The virtual object may also be an operation object, which is an object that moves in accordance with the movement of a part (e.g., hand) of the body of the user 5. For example, the operation object may include a hand object corresponding to the hand of the user 5 wearing the HMD 120, a finger object corresponding to a finger of the user 5, and the like. An object operated in association with the hand object may also function as an operation object that moves in accordance with motion of the hand of the user 5. For example, a stick-like object grasped by the hand object, such as a touch pen, may function as the operation object. In the following description, in some instances, the virtual object is simply referred to as “object”.

The chat control module 1426 performs control for chatting with the avatar of another user staying in the same virtual space 11. For example, the chat control module 1426 transmits data required for chatting via the virtual space 11 (e.g., sound data input to microphone 170) to the server 600. The chat control module 1426 outputs the sound data of another user received from the server 600 to a speaker (not shown). As a result, sound-based chat is implemented. The chat control module 1426 transmits and receives the data to be shared among other users to and from the HMD set 110 of the other users via the server 600. The data to be shared is, for example, motion detection information for controlling a motion of a part of the body of the avatar.

The motion detection data is, for example, direction data, eye tracking data, face tracking data, and/or hand tracking data. The direction data is information indicating the position and inclination of the HMD 120 detected by the HMD sensor 410 and the like. The eye tracking data is information indicating the line-of-sight direction detected by the eye gaze sensor 140 and the like. The face tracking data is data generated by image analysis processing on image information acquired by the first camera 150 and the second camera 160 of the HMD 120A, for example. The face tracking data is information indicating a temporal change in the position and the size of each part of the face of the user 5A. The hand tracking data is, for example, information indicating motion of the hand of the user 5A detected by the motion sensor 420 and the like.

In at least one embodiment, the chat control module 1426 transmits and receives information including sound data and motion detection data (hereinafter referred to as “avatar information”) as information to be shared among the users, to and from the HMD set 110 via the server 600. The avatar information is transmitted and received by utilizing the function of the communication control module 250.

The virtual space recording module 1427 performs control, such as acquisition, storage, and playback of recording data, for playing back an omnidirectional moving image, which is a video in all directions from a predetermined position in the virtual space 11 for a predetermined period. The detailed processing to be executed by the virtual space recording module 1427 is described later.

When any of the objects arranged in the virtual space 11 has collided with another object, the control module 510 detects that collision. The control module 510 can detect, for example, the timing of a given object touching another object, and performs processing determined in advance when the timing is detected. The control module 510 can detect the timing at which objects that are touching each other separate from each other, and performs processing determined in advance when the timing is detected. The control module 510 can also detect a state in which objects are touching each other by, for example, executing a known hit determination based on a collision area set for each object.

The content information 1431 includes, for example, content to be played back in the virtual space 11 and information for arranging an object to be used in that content. Examples of the content may include a game and content representing scenery similar to that of the real world. Specifically, the content information 1431 may include virtual space image data (panorama image 13) defining a background of the virtual space 11 and definition information on an object arranged in the virtual space 11. The definition information on the object may include rendering information for rendering the object (e.g., information representing a design such as a shape and color of the object), information indicating an initial arrangement of the object, and the like. The definition information on an object autonomously moving based on a motion pattern set in advance may include information (e.g., program) indicating the motion pattern. An example of a motion based on a motion pattern determined in advance is a simple repetitive motion like a motion in which an object imitating grass sways in a certain pattern.

The object information 1432 includes information indicating the state of each object arranged in the virtual space 11 (state that may change in accordance with the progress of the game and operations by the user 5, for example). Specifically, the object information 1432 may include position information indicating the position of each object (e.g., position of center of gravity set for an object). The object information 1432 may further include motion information indicating a motion of a deformable object (i.e., information for identifying the shape of the object). Examples of a deformable object include objects that, like the avatar described above, have a part such as a head, a torso, and hands, and that can independently move each part in accordance with a motion of the user 5.

The user information 1433 includes, for example, a program for causing the computer 200 to function as the control device for the HMD set 110 and an application program that uses each piece of content stored in the content information 1431.

### [Control Structure]

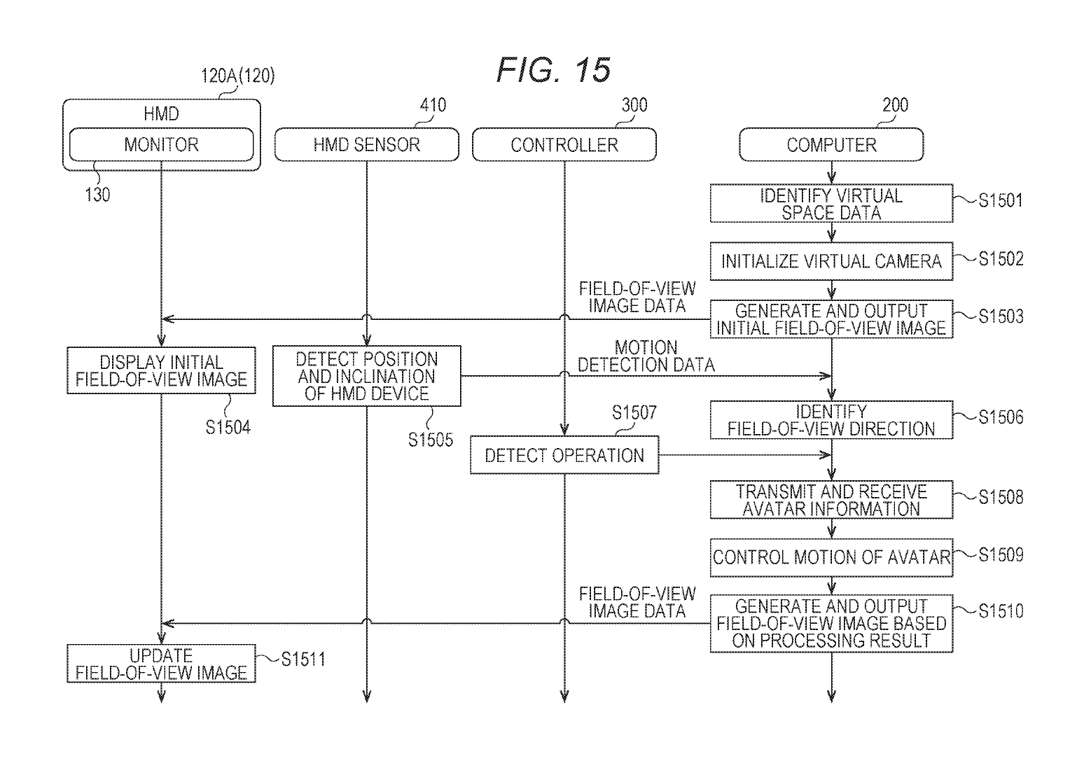

With reference to FIG. 15, the control structure of the computer 200 according to at least one embodiment of this disclosure is described. FIG. 15 includes processing to be executed by the HMD set 110, which is used by the user 5, to provide the virtual space 11 to the user 5 according to at least one embodiment of this disclosure. The same processing is also executed by the other HMD sets 110B and 110C.

In Step S1501, the processor 210 of the computer 200 serves as the virtual space definition module 1424 to identify the virtual space image data (panoramic image 13) forming the background of the virtual space 11, and define the virtual space 11.

In Step S1502, the processor 210 serves as the virtual camera control module 1421 to initialize the virtual camera 14. For example, in a work area of the memory, the processor 210 arranges the virtual camera 14 at the center defined in advance in the virtual space 11, and matches the line of sight of the virtual camera 14 with the direction in which the user 5 faces.

In Step S1503, the processor 210 serves as the field-of-view image generation module 1429 to generate field-of-view image data for displaying an initial field-of-view image. The generated field-of-view image data is transmitted to the HMD 120 by the communication control module 540 via the field-of-view image generation module 1429.

In Step S1504, the monitor 130 of the HMD 120 displays a field-of-view image based on a signal received from the computer 200. The user 5A wearing the HMD 120A may recognize the virtual space 11 through visual recognition of the field-of-view image.

In Step S1505, the HMD sensor 410 detects the position and inclination of the HMD 120 based on a plurality of infrared rays emitted from the HMD 120. The detection results are transmitted to the computer 200 as motion detection data.

In Step S1506, the processor 210 serves as the field-of-view region determination module 1422 to identify, based on the position and inclination of the HMD 120A, the field-of-view direction of the user 5A wearing the HMD 120A (i.e., position and inclination of virtual camera 14). The processor 210 executes the application program and arranges the object in the virtual space 11 based on a command included in the application program.

In Step S1507, the controller 300 detects an operation performed by the user 5A in the real space. For example, in at least one aspect, the controller 300 detects that a button has been pressed by the user 5A. In at least one aspect, the controller 300 detects a motion of both hands of the user 5A (e.g., waving both hands). A signal indicating details of the detection is transmitted to the computer 200.

In Step S1508, the processor 210 serves as the chat control module 1426 to transmit and receive avatar information to and from another HMD set 110 (in this example, HMD sets 110B and 110C) via the server 600.

In Step S1509, the processor 210 serves as the virtual object control module 1425 to control a motion of the avatar associated with each user based on the avatar information on each user 5. In at least one embodiment, the term “avatar” is synonymous with “avatar object”.

In Step S1510, the processor 210 serves as the field-of-view image generating module 1429 to generate field-of-view image data for displaying a field-of-view image based on the result of the processing in Step S1509, and output the generated field-of-view image data to the HMD 120.

In Step S1511, the monitor 130 of the HMD 120 updates a field-of-view image based on the received field-of-view image data, and displays the updated field-of-view image.

The processing of Step S1505 to Step S1511 is periodically repeatedly executed.

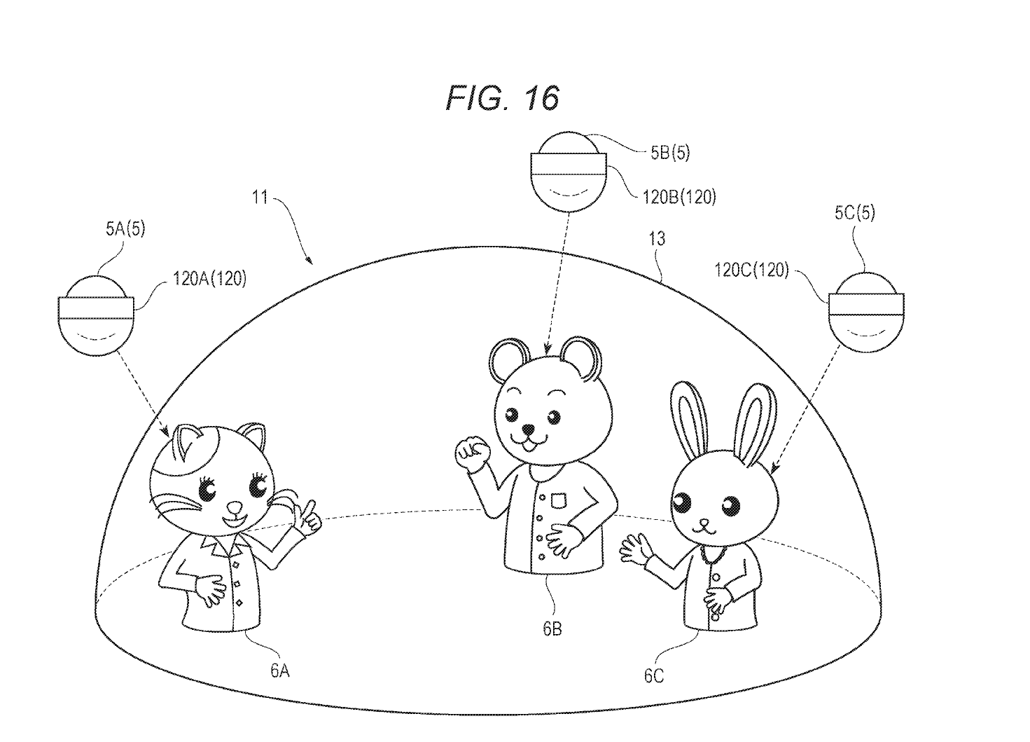

FIG. 16 is a schematic diagram of the virtual space 11 shared by a plurality of users according to at least one embodiment of this disclosure. In FIG. 16, the avatar 6A associated with the user 5A wearing the HMD 120A, the avatar 6B associated with the user 5B wearing the HMD 120B, and the avatar 6C associated with the user 5C wearing the HMD 120C are arranged in the same virtual space 11. In such a virtual space 11 shared by a plurality of users, a communication experience, for example, chat with other users via the avatars 6A to 6C, can be provided to each user.

In at least this example, each of the avatars 6A to 6C is defined as a character object imitating an animal (cat, bear, or rabbit). The avatars 6A to 6C include, as parts capable of moving in association with a motion of a user, a head (face direction), eyes (e.g., line of sight and blinking), a face (facial expression), and hands. The head is a part that moves in association with a motion of the HMD 120 detected by the HMD sensor 410 or the like. The eyes are a part that moves in association with the motion and change in line of sight of the eyes of a user detected by the second camera 160 and the eye gaze sensor 140 or the like. The face is a part in which a facial expression determined based on face tracking data, which is described later, is translated. The hands are parts that move in association with the motion of the hands of the user detected by the motion sensor 420 or the like. The avatars 6A to 6C each include a body portion and arm portions displayed in association with the head and the hands. Motion control of legs lower than hips is complicated, and hence the avatars 6A to 6C do not include legs.

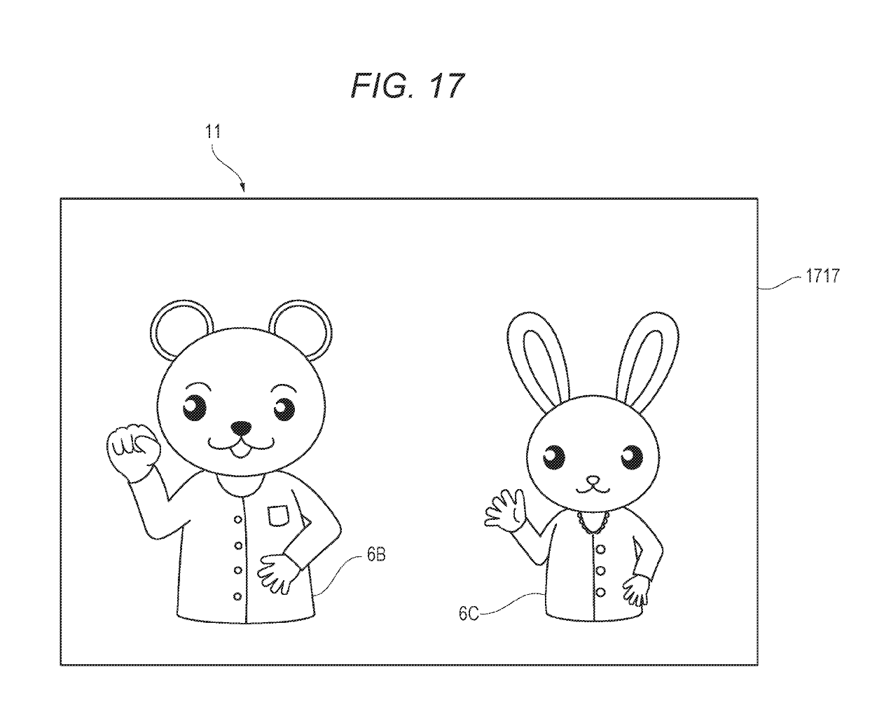

The visual field of the avatar 6A matches the visual field of the virtual camera 14 in the HMD set 110A. As a result, a field-of-view image 1717 in a first-person perspective of the avatar 6A is provided to the user 5A. More specifically, a virtual experience as if the user 5A were present as the avatar 6A in the virtual space 11 is provided to the user 5A. FIG. 17 is a diagram of the field-of-view image 1717 to be provided to the user 5A via the HMD 120A according to at least one embodiment of this disclosure. A field-of-view image in a first-person perspective of each of the avatars 6B and 6C is similarly provided to each of the users 5B and 5C.

### [Storage and Playback of Recording Data]

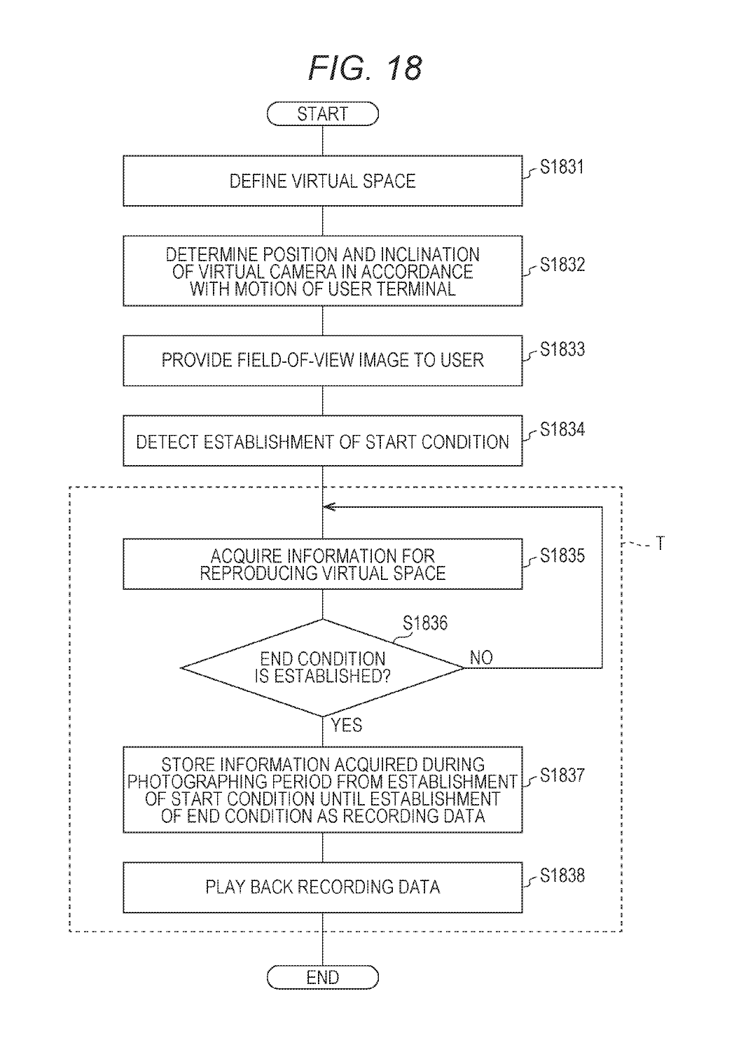

The processing procedures relating to the storage and playback of recording data are now described with reference to FIG. 18 to FIG. 22. The recording data is data for playing back an omnidirectional moving image (360-degree moving image), which is a video in all directions from a predetermined designated position in the virtual space 11 for a predetermined photographing period.

First, the series of processing procedures relating to the storage and playback of the recording data is described with reference to FIG. 18. In at least one embodiment, the processing relating to the storage and playback of the recording data is executed by the HMD set 110A. However, in at least one embodiment, this processing may be executed by another HMD set 110B or 110C, or a part or all of the processing may be executed by the server 600.

In Step S1831, the processor 210 of the HMD set 110A (hereinafter simply referred to as “processor 210”) serves as the virtual space definition module 1424 to define the virtual space 11. This processing corresponds to the processing of Step S1501 of FIG. 15. More specifically, the processor 210 defines the virtual space 11 by generating virtual space data defining the virtual space 11. The virtual space data includes the above-mentioned content information 1431 and object information 1432.

In Step S1832, the processor 210 determines the position and inclination of the virtual camera 14 in the virtual space 11 in accordance with a motion of the HMD 120A. This processing corresponds to a portion of the processing of Step S1506 of FIG. 15.

In Step S1833, the processor 210 provides the user 5 with the field-of-view image 1717 (see FIG. 17). Specifically, the processor 210 generates the field-of-view image 1717 based on a motion of the HMD 120A (i.e., position and inclination of virtual camera 14) and the virtual space data defining the virtual space 11, and displays the field-of-view image 1717 on the monitor 130 of the HMD 120A. This processing corresponds to the processing of Step S1510 of FIG. 15.

Next, the processor 210 serves as the virtual space recording module 1427 to execute the processing of Step S1834 to Step S1838. The processing of Step S1834 to Step S1837 is processing for storing the recording data, and the processing of Step S1838 is processing for playing back the recording data. The above-mentioned processing of Step S1832 and Step S1833 (i.e., updating of field-of-view image 1717 in accordance with motion of HMD 120A) are also continuously and repeatedly executed while Step S1834 to Step S1838 are executed.

In Step S1834, the processor 210 detects establishment of a start condition. The start condition is a condition determined in advance as a trigger to start storage of the recording data. The processor 210 detects establishment of the start condition based on, for example, an input operation on the controller 300 and a user operation on a menu screen displayed in the field-of-view image. When establishment of the start condition is detected, the processor 210 advances the processing to Step S1835, and starts storage of the recording data.

In Step S1835, the processor 210 acquires information for reproducing at least a portion of the virtual space 11 based on the virtual space data defining the state of the virtual space 11. More specifically, the processor 210 acquires information for playing back an omnidirectional moving image, which is a video in all directions from a designated position in the virtual space 11. In at least one example, which is described later, the designated position corresponds to a reference position RP. In at least one example, which is described later, the designated position corresponds to any position selected afterwards. The information for playing back the omnidirectional moving image is described later in more detail together with the description of the first processing example and the second processing example.

In Step S1836, the processor 210 determines whether or not an end condition is established. The end condition is a condition determined in advance as a trigger for ending storage of the recording data. The processor 210 determines that the end condition is established based on, for example, an input operation on the controller 300 and a user operation on a menu screen displayed in the field-of-view image. The processor 210 periodically executes the processing of Step S1835 (Step S1836: NO→Step S1835) at a predetermined time interval until the end condition is established. When the end condition is established (Step S1836→YES), the processor 210 advances the processing to Step S1837.

In Step S1837, the processor 210 stores, as the recording data, the information acquired in Step S1835 during the photographing period from establishment of the start condition until establishment of the end condition. For example, each piece of information acquired in Step S1835 is stored as recording data in association with time information (e.g., acquisition time) indicating the point in time at which each piece of information is acquired. The recording data may be, for example, stored in the memory module 530, or may be transmitted to the server 600 and stored on the server 600 in order to be shared among the plurality of HMD sets 110.

In Step S1838, for example, when a playback instruction operation determined in advance has been received from the user 5, the processor 210 plays back the recording data recorded in Step S1837. More specifically, the processor 210 generates an omnidirectional moving image based on the recording data, and plays back the generated omnidirectional moving image on a virtual screen provided in the virtual space 11. The virtual screen is constructed of, for example, a plurality of meshes (portions in which panoramic image 13 is displayed) provided on a spherical surface of a celestial virtual space 11. The virtual screen may also be an object (e.g., a dome screen-like object such as a planetarium) generated in the virtual space 11.

In some embodiments, the omnidirectional video is a two-dimensional video displayed on a screen defined by virtual space 11. For example, in at least one embodiment, panoramic images 13 in FIG. 4 are generated by displaying the omnidirectional video on the screen defined by virtual space. In some embodiments, the omnidirectional video provides a background for the three-dimensional virtual space 11.

Next, at least one example of the processing (portion surrounded by dashed line T in flowchart of FIG. 18) for storing and playing back the recording data is described. In at least one example, the recording data is acquired as video data similar to data photographed by a 360-degree camera in the real space. For example, in order to acquire an omnidirectional image from a reference position set in the virtual space 11, the processor 210 acquires an image corresponding to each of a plurality of directions that are determined in advance and centered about the reference position.

Each image corresponding to one of those directions is an image similar to the above-mentioned field-of-view image. One omnidirectional image is generated by joining the acquired plurality of images by known software processing. The processor 210 periodically acquires images corresponding to each of the plurality of directions required for generating such an omnidirectional image as information for reproducing a portion that is visually recognizable from the reference position in the virtual space 11. The above-mentioned video data may be formed from a plurality of images periodically acquired in this way. In this manner, in the first processing example, video data as if photographed by a virtual 360-degree camera arranged at the reference position in the virtual space 11 is acquired as the recording data.

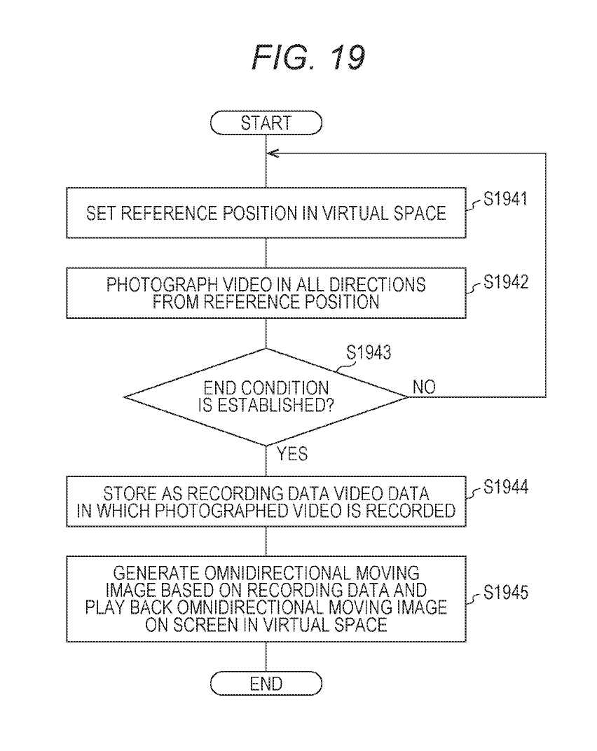

The series of processing procedures of at least one example described above is now described with reference to the flowchart in FIG. 19. The processing of Step S1941 to Step S1944 corresponds to the processing of Step S1835 to Step S1837 of FIG. 18, and the processing of Step S1945 corresponds to the processing of Step S1838 of FIG. 18.

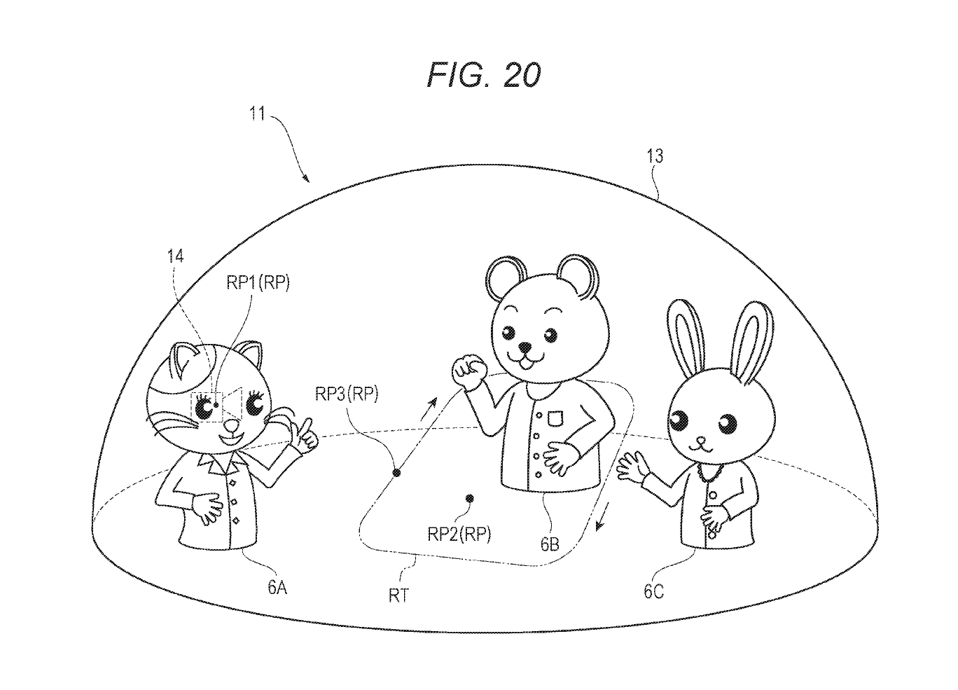

In Step S1941, the processor 210 sets the reference position in the virtual space 11. The reference position corresponds to the position of the above-mentioned virtual 360-degree camera. FIG. 20 is a diagram of the reference positions RP (reference positions RP1 to RP3) according to at least one embodiment of this disclosure.

Like the reference position RP1 of FIG. 20, the processor 210 may set the position of the virtual camera 14, which moves together with the motion of the HMD 120A, as the reference position RP1. In this case, when the virtual camera 14 moves, the reference position RP1 also moves together with the virtual camera 14. When such a reference position RP1 is set, video data is acquired in all directions, including the field-of-view image provided to a certain user (user 5A in this case). In other words, video data is acquired that enables a past virtual experience of a certain user to be re-experienced.

Like the reference position RP2 of FIG. 20, the processor 210 may also set a fixed point determined in advance in the virtual space 11 as the reference position RP2. The reference position RP2 may be determined by a default setting or may be determined by a user operation or the like. When chatting is performed via the avatars 6A to 6C like in FIG. 20, the reference position RP2 is set to a position enabling, for example, the faces of all the avatars 6A to 6C to be shown. In this case, video data appropriately photographing the state of the chat among the users via the avatars 6A to 6C is acquired.

Like the reference position RP3 of FIG. 20, the processor 210 may also dynamically set the reference position RP3 by moving the reference position RP3 based on a movement pattern determined in advance. More specifically, the processor 210 may move the reference position RP3 at a predetermined speed along a route RT generated based on the movement pattern. In this case, video data is acquired as if photographed while a virtual photographer moved along the route RT. The route RT is generated, for example, in accordance with a mode selected by the user 5A from among a plurality of modes prepared in advance. The mode is information indicating a rule that serves as a reference when determining the movement pattern (i.e., route RT) of the reference position RP3. Specific examples of the mode include a mode in which an avatar associated with a user 5 having a large quantity of utterances is shown and a mode in which each avatar is shown as equally as possible. When the former mode is used, for example, the processor 210 identifies the user 5 having the largest quantity of utterances based on the sound data of each of the plurality of users 5, and determines the route RT such that the reference position RP3 is included in an area within a certain range from the avatar of the identified user 5. The processor 210 generates a route RT in accordance with each mode by, for example, executing a program (program stored in memory module 530) prepared in advance corresponding to each mode.

In place of being selected by the user 5A, the mode may be determined by a determination model generated by known machine learning. Such a determination model maybe generated, for example, by the following processing. Specifically, the server 600 collects for a certain period correct data in which the modes selected by the user 5 when recording the recording data in each HMD set 110 is associated with the attribute information representing a characteristic of the user 5. The attribute information is, for example, the gender, age, and/or hobbies of the user 5 registered in advance in the HMD set 110. The server 600 generates the determination model by executing known machine learning using the collected correct data. This determination model is a program inputting attribute information on the user as an explanatory variable and outputting as a target variable a mode assumed that tends to be selected by the user having that attribute information. Each HMD set 110 downloads the determination model generated by the server 600, and stores the determination model in the memory module 530. With such a configuration, the processor 210 may generate the route RT based on the mode obtained by inputting the attribute information on the user 5A to the determination model. The attribute information on the user 5A may be stored in advance in the memory module 530, for example.

In Step S1942, the processor 210 photographs a video in all directions centered about the reference position RP. Specifically, the processor 210 acquires images corresponding to each of a plurality of directions from the reference position RP.

In Step S1943, the processor 210 determines whether or not the above-mentioned end condition is established. The processor 210 periodically executes the processing of Step S1941 and Step S1942 (Step S1943: NO→Step S1941→Step S1942) until the end condition is established. However, when the reference position RP2, which is a fixed point, has been set, updating the reference position RP2 is avoided in some instances, and hence the processor 210 may omit the processing of Step S1941. When the end condition is established (Step S1943: YES), the processor 210 advances the processing to Step S1944.

In Step S1944, the processor 210 stores, as the recording data, video data formed from the video (plurality of images) photographed in Step S1942 during the photographing period from establishment of the start condition to establishment of the end condition.

In Step S1945, for example, when a playback instruction operation has been received from the user 5, the processor 210 plays back the recording data recorded in Step S1944. Specifically, the processor 210 generates an omnidirectional moving image based on the recording data. In the first processing example, because the recording data is the above-mentioned video data, the processor 210 may handle the video data as omnidirectional moving image. The processor 210 then plays back the omnidirectional moving image on the virtual screen. For example, the processor 210 assigns and displays the video corresponding to each direction included in omnidirectional moving image to a corresponding region (e.g., corresponding mesh) on the virtual screen.

In at least one example, similar to photography by a 360-degree camera in the real space, video data for playing back a 360-degree moving image centered about the reference position RP in the virtual space 11 can be stored as the recording data.

Next, at least one example of the processing (portion surrounded by dashed line T in flowchart of FIG. 18) for storing and playing back the recording data is described. In at least one example, the recording data includes the content information 1431, and the object information 1432 in the photographing period (position information on each object and motion information on each deformable object). The object information 1432 obtained in the photographing period is object information 1432 indicating the state at each point in time obtained by dividing the photographing period into time intervals determined in advance.

The processor 210 may also acquire information indicating the positions of a plurality of parts, which are determined in advance, of the deformable object as the motion information on the deformable object. The plurality of parts determined in advance of the deformable object are parts set in advance as points required in order to identify the shape and posture of the deformable object. For example, when the deformable object is an avatar, the plurality of parts may include the parts corresponding to the joints of the avatar.

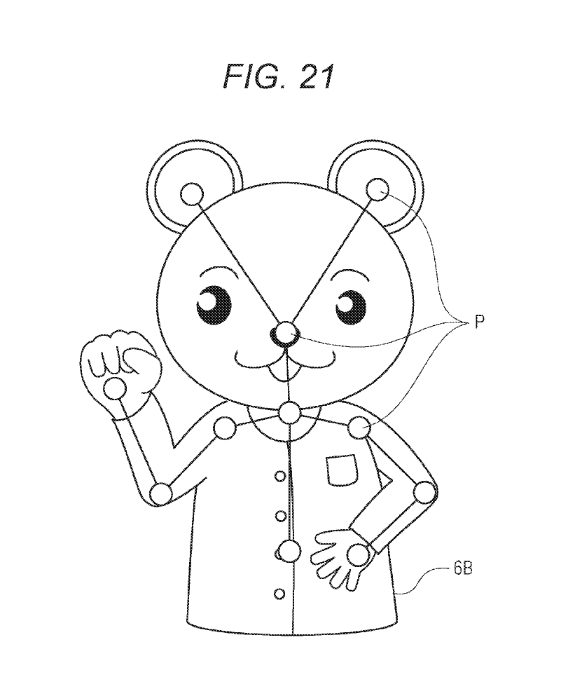

An example of the plurality of parts is now described with reference to FIG. 21. FIG. 21 is a diagram of a plurality of parts P set for the avatar 6B according to at least one embodiment of this disclosure. In this case, as the motion information, the processor 210 may acquire position information (e.g., coordinate values in XYZ coordinates of virtual space 11) on a plurality of (eleven in this case) the parts P required in order to identify the shape and posture of the object (avatar 6B). Based on the position of each part P, the position and posture of the bones connecting adjacent parts P are identified, and based on the identified bone positions and postures, the skeleton of the deformable object is identified. The shape and posture of the deformable object can be reproduced by adding muscles, skin tissue, and the like to the identified skeleton (applying an appearance design included in the definition information on the deformable object to the identified skeleton). More specifically, the processor 210 can identify a motion (shape and posture) of the deformable object based on the definition information (e.g., rendering information) on the deformable object and the motion information. In this way, the data amount of the motion information can be suppressed by using, as the motion information, position information on parts (parts P) of the deformable object having a relatively small amount of data, in place of data (e.g., image data) including a specific appearance design of a deformable object.

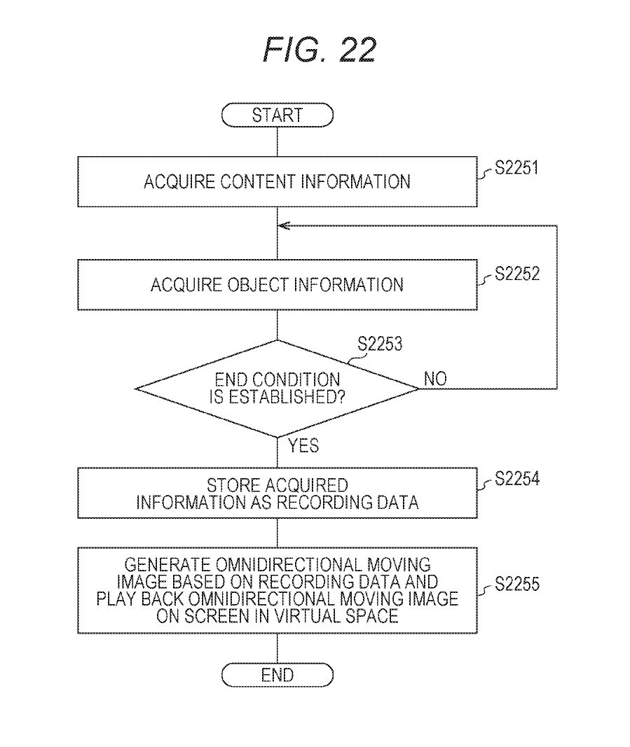

The series of processing procedures of at least one example described above is now described with reference to the flowchart in FIG. 22. The processing of Step S2251 to Step S2254 corresponds to the processing of Step S1835 to Step S1837 of FIG. 18, and the processing of Step S2255 corresponds to the processing of Step S1838 of FIG. 18.

In Step S2251, the processor 210 acquires the content information 1431. In Step S2252, the processor 210 acquires the object information 1432 (position information on each object and motion information on each deformable object).

In Step S2253, the processor 210 determines whether or not the above-mentioned end condition is established. The processor 210 periodically executes the processing of Step S2252 (Step S2253: NO, Step S2252) until the end condition is established. As a result, at each time point included in the photographing period, the position information on the object arranged in the virtual space 11 and the motion information on the deformable object are acquired. When the end condition is established (Step S2253: YES), the processor 210 advances the processing to Step S2254.

In Step S2254, the processor 210 stores the content information 1431 acquired in Step S2251 and the object information 1432 (position information on each object and motion information on each deformable object) acquired in Step S2252 during the photographing period as recording data.

In Step S2255, for example, when a playback instruction operation has been received from the user 5A, the processor 210 plays back the recording data recorded in Step S2254. Specifically, the processor 210 identifies the virtual space 11 (i.e., state of virtual space 11) based on the content information 1431 and the object information 1432 (position information on each object and motion information on each deformable object) included in the recording data. The processor 210 then generates an omnidirectional moving image, which is a video in all directions from a predetermined viewpoint position in the identified virtual space 11. The predetermined viewpoint position is any position in the virtual space 11, and is, for example, a position selected by the user 5A.

More specifically, the processor 210 acquires an image corresponding to each of a plurality of directions from the predetermined viewpoint position in an internally reproduced virtual space 11 at each time point included in the photographing period. The processor 210 then generates an omnidirectional image (omnidirectional image centered about the predetermined viewpoint position) at each time point by joining the plurality of acquired images by known software processing. The processor 210 may generate an omnidirectional moving image by arranging the omnidirectional images at each time point generated in this way in chronological order. Then, the processor 210 plays back the generated omnidirectional moving image on the virtual screen.

In at least one example, the virtual space 11 in the photographing period based on the recording data is internally reproduced. As a result, scenery that is visually recognizable when the user 5A (i.e., avatar 6A) is present at a predetermined viewpoint position in an internally-reproduced past virtual space 11 (scenery that is visually recognizable by turning the head of the avatar 360 degrees in the horizontal direction) can be provided as an omnidirectional moving image to the user 5A.

To give a supplementary description, in at least one example, information on parts that cannot be visually recognized from the reference position RP in the virtual space 11 are not recorded as recording data, and hence those parts cannot be played back as an omnidirectional moving image. Meanwhile, in at least one example, an entire past virtual space 11 can be three-dimensionally reproduced based on the virtual space data (content information 1431 and object information 1432) in the photographing period, and hence an omnidirectional moving image can be generated and played back from any position in the past virtual space 11. Therefore, in at least one example, the user 5A can look back on a past virtual experience from a viewpoint different from the viewpoint at the time of the past virtual experience.

For example, the position of the virtual camera 14 at the present time of the user 5A, who is performing the virtual experience, may be set as the above-mentioned predetermined viewpoint position. In this case, when the position of the virtual camera 14 moves during playback of the omnidirectional moving image, the center position of the omnidirectional moving image provided to the user 5A may also be changed in accordance with the movement of the virtual camera 14. With such a configuration, by moving in the virtual space 11 at the present time, the user 5A can enjoy changes in the scenery as if he or she were moving in the same manner in the past virtual space 11 via the omnidirectional moving image that is played back on the virtual screen. An omnidirectional moving image that has been processed in a similar manner may be provided to the other users 5B and 5C as well. Specifically, an omnidirectional moving image different for each user may be generated and played back in accordance with the position of the virtual camera of each of the users 5A to 5C. With such a configuration, the other users 5B and 5C are provided with the same style of enjoyment as that of the user 5A via the omnidirectional moving image played back on the virtual screen.

### [Extraction and Editing of Two-dimensional Image Data]

In at least one example, two-dimensional image data is edited and extracted. The two-dimensional image data is data obtained by recording the state of the virtual space 11 at a certain point in time as a two-dimensional image, like a photograph in the real world. The two-dimensional image data corresponds to a portion of the virtual space 11 viewed from a predetermined position in the virtual space 11. For example, two-dimensional image data may be generated as a portable display object imitating a photograph in the real world. In this case, the two-dimensional image data is sharable among a plurality of users, for example. The two-dimensional image data may also be uploaded to another system (e.g., social networking service (SNS) site) via the Internet or the like. In this case, posting two-dimensional image data photographed in the virtual space 11 on an SNS site or the like is possible, which enables enjoyment styles such as sharing a past experience in the virtual space 11 with other users in the real space.

In at least one example, two-dimensional image data may be generated by extracting a two-dimensional image corresponding to a specific position and direction from the generated omnidirectional moving image. In at least one example, the recording data is video data that shows only targets that can be visually recognized from the reference position, and hence only two-dimensional image data that is in a visually-recognizable range from the reference position can be extracted. In at least one example, freely editing the position and the like of the objects arranged in the two-dimensional image data is difficult. For example, when editing processing for shifting the position of an object is performed, data corresponding to the portion in which the object was originally shown (i.e., data such as a background hidden by the object) is not included in the recording data, and hence the data corresponding to that part is supplemented in some way. In this way, in at least one example, there are restrictions similar to those imposed when a still image is extracted from a moving image photographed in the real space and the extracted still image is edited. Meanwhile, in at least one example, recording data capable of three-dimensionally reproducing the state of a past virtual space 11 is acquired, and hence two-dimensional image data obtained by photographing any target in the virtual space 11 from any direction may be generated. Even when editing work such as that described above is performed, data corresponding to the portion in which the object was originally shown is acquired from the recording data. Therefore, in at least one example, two-dimensional image data having a high degree of freedom can be generated without being subject to the same restrictions as in the real world.

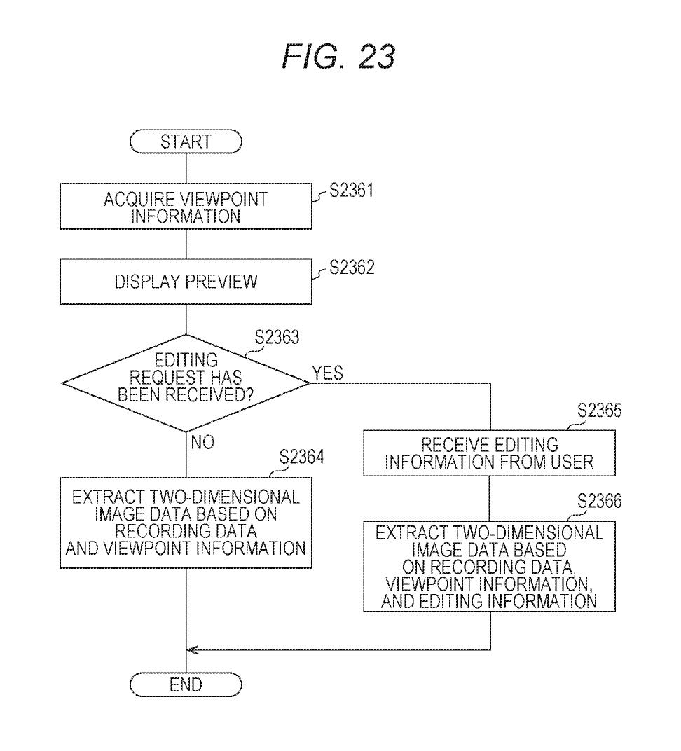

The series of processing procedures relating to the extraction and editing of the above-mentioned two-dimensional image data is now described with reference to the flowchart in FIG. 23. The processor 210 serves as the virtual space recording module 1427 to execute the processing of Step S2361 to Step S2366.

In Step S2361, the processor 210 acquires viewpoint information on the virtual space 11 from the user 5A. The viewpoint information is information for identifying the field-of-view region in the virtual space 11, and is information indicating the position and inclination in the virtual space 11, for example. Information indicating the position and inclination of the virtual camera 14 is one type of viewpoint information. The processor 210 identifies, based on the viewpoint information, a field-of-view region (hereinafter referred to as “specific field-of-view region”) corresponding to the viewpoint information. The specific field-of-view region is the same region as the field-of-view region 15 in FIG. 6 and FIG. 7, for example.

In Step S2362, the processor 210 internally reproduces the state (e.g., arrangement of objects and motions) of the virtual space 11 in the past photographing period based on the recording data to be processed. Then, the processor 210 displays, of the internally reproduced past virtual space 11, a preview of a portion overlapping the specific field-of-view region. For example, the processor 210 determines provisional two-dimensional image data based on the internally reproduced past virtual space 11 and the specific field-of view region. The two-dimensional image data is determined by processing similar to the processing for determining the field-of-view image provided to the user 5A based on the field-of-view region 15. The processor 210 then displays a preview of the determined two-dimensional image data in the virtual space 11. In at least one embodiment, the processor 210 generates in the virtual space 11 a display object D representing the two-dimensional image data.

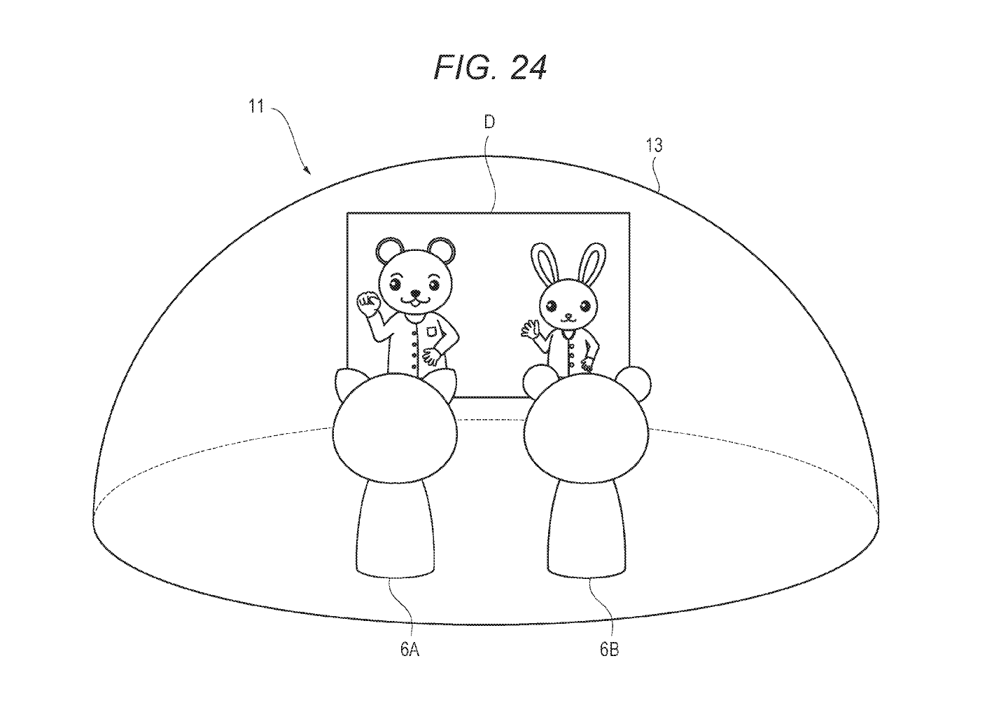

FIG. 24 is a diagram of the display object D arranged in the virtual space 11 according to at least one embodiment of this disclosure. The display object D is an object on which an image (texture) generated based on the two-dimensional image data is attached. Arranging the display object D in the virtual space 11 enables a plurality of users 5 sharing the virtual space 11 (in at least one example, users 5A and 5B corresponding to avatars 6A and 6B) to confirm together the content of the two-dimensional image data in the virtual space 11. The display object D may be an object fixed at a predetermined position in the virtual space 11 or may be a movable object. An example of the latter is an object imitating a photograph, which is portable via an avatar.

In Step S2363, the processor 210 waits to receive an editing request from the user 5. The editing request may be input by the following user operation, for example.

The processor 210 serves as the virtual object control module 1425 to receive input on the display object D via a hand object. Specifically, the processor 210 receives input from the user 5 for changing the content of the two-dimensional image data. For example, there may be room for improvement in the composition of the two-dimensional image data, for example, the distance between the objects (e.g., avatars) to be photographed may be too far, the objects may overlap each other, or objects such as trees may worsen the composition. In such a case, the user 5 can change the position and the like of an object in the two-dimensional image data by an input operation on the display object D via the operation object (hand object or object associated with hand object). Specifically, an operation is performed on the display object D with a feeling as if a drag operation were performed on the touch panel.

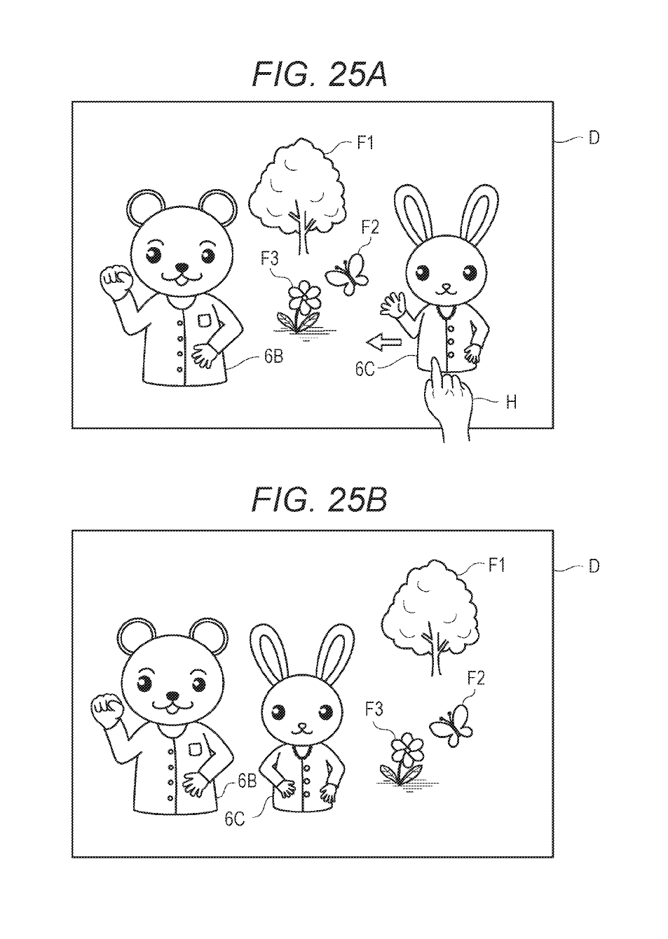

FIG. 25A is a diagram of an input operation on a display object according to at least one embodiment of this disclosure. First, an operation example of objects that do not have a deformable shape (hereinafter referred to as “non-deformable objects”) F1, F2, and F3 is described. At least one example of an operation example on the non-deformable object F1 is described below. For example, when a hand object H approaches within a certain distance or less from the non-deformable object F1 displayed on the display object D, the processor 210 detects contact between the hand object H and the non-deformable object F1. Then, when the hand object H moves while the hand object H and the non-deformable object F1 are still in contact with each other, the processor 210 detects a movement operation of moving the non-deformable object F1, and acquires information indicating the amount of movement (e.g., vector) as editing information.

Next, an operation example for avatars 6B and 6C, which are deformable objects, is described. At least one example of an operation example for the avatar 6C is described below. For the avatar 6C, which is a deformable object, in addition to the same movement operation as the operation for moving the non-deformable object F1, an operation of deforming (i.e., changing) the shape of the avatar 6C is also possible. For example, the processor 210 receives from the user 5 an operation of selecting any one of the plurality of parts P of the avatar 6C displayed on the display object D as an operation target. When the hand object H moves while the hand object H and the selected part P are still in contact with each other, the processor 210 detects a deformation operation for moving the part P, and acquires information indicating the amount movement (e.g., vector) as editing information.

The operation on the object displayed on the display object D maybe performed directly by the hand object H or may be performed by an object (e.g., an object imitating a touch pen or the like) associated with the hand object H.

When an editing request from the user 5 has not been received (Step S2363: NO), in Step S2364, the processor 210 extracts the two-dimensional image data displayed as a preview on the display object D.

On the other hand, when an editing request from the user 5 has been received (Step S2363: YES), in Step S2355, the processor 210 receives the editing information from the user 5. The editing information is information for redefining a portion of the recording data (in at least one embodiment, position information on the object or motion information on the deformable object). This redefinition operation is an operation in which the content of already defined data is rewritten to different content.

In Step S2366, the processor 210 extracts, of the virtual space 11 in the photographing period identified based on the recording data and the editing information, the portion of the identified field-of-view region (region determined based on viewpoint information designated by user 5) as two-dimensional image data. More specifically, the processor 210 internally reproduces the state (e.g., arrangement of objects and motions) of the virtual space 11 based on the recording data redefined based on the editing information. Then, the processor 210 extracts two-dimensional image data based on the internally reproduced virtual space 11 and the specific field-of view region. As a result, two-dimensional image data in which the edited state has been translated is obtained.

Several examples relating to the redefinition of a portion of the recording data (position information on an object or motion information on a deformable object) based on the editing information are now described.

When an operation of moving the non-deformable object displayed on the display object D is performed, as described above, the processor 210 acquires information indicating the movement amount as editing information. In this case, the processor 210 redefines, based on that movement amount, the position information on the non-deformable object set as the operation target among the virtual space data associated with the two-dimensional image data. More specifically, the processor 210 redefines the position (e.g., XYZ coordinate values) of the non-deformable object after being moved from an original position by the amount of movement as the new position information on the non-deformable object.

When an operation of moving the deformable object displayed on the display object D is performed, as described above, the processor 210 acquires information indicating the movement amount as editing information. In this case, the processor 210 redefines, based on that movement amount, the position information on the deformable object set as the operation target among the virtual space data associated with the two-dimensional image data by the same processing as described above. When the deformable object is to be moved, the position of each of the plurality of parts P of the deformable object are also moved in the same manner. Therefore, the processor 210 also redefines the motion information on the deformable object based on the movement amount. Specifically, the processor 210 redefines the position information on each of the plurality of parts P included in the motion information on the deformable object based on the movement amount.

When an operation of moving a part (part P) of the deformable object (i.e., an operation of deforming the deformable object) displayed on the display object D is performed, as described above, the processor 210 acquires information indicating the movement amount. In this case, the part P is a part corresponding to a joint of the avatar, and parts P are connected to another part by a bone. Therefore, when the position of one part P is changed, the position of another part P may be changed as a result of the change. The influence of the change in the position of one part P on the position of another part P may be determined by performing a calculation determined in advance on a skeleton model including the plurality of parts P and the bones connecting the parts P. As a result of executing such a calculation, the processor 210 calculates the movement amount of another part P that is affected when the part P of the deformable object, which is the operation target, is moved by the above-mentioned movement amount. Then, the processor 210 redefines, of the motion information on the deformable object set as the operation target, the position information on the part P set as the operation target based on the movement amount. The processor 210 also redefines based on the calculated movement amount the position information on the other parts P that are affected.

FIG. 25B is a diagram of an edited two-dimensional image data displayed on the display object D according to at least one embodiment of this disclosure. In at least one example, the non-deformable objects F1, F2, and F3 have moved as a whole to the right side from their initial positions. The avatar 6C, which is a deformable object, has moved closer to the avatar 6B than its initial position, and the shape of the right hand part is changed from a raised state to a lowered state.

In at least one example described above, each of the users 5A to 5C is provided with an experience of looking back at a past virtual experience (state of virtual space 11 in photographing period) in the virtual space 11. Providing such a retrospective experience enables the entertainment value of the virtual experience of each of the users 5A to 5C to be improved. Particularly through storage of the virtual space data in the photographing period as recording data permitting three-dimensionally reproducing the past virtual space 11 based on the recording data. As a result, the user 5 is provided with a function of looking back at the past virtual experience from any viewpoint position. In at least one embodiment, the user 5 is provided with a function of generating two-dimensional image data having a composition desired by the user 5.

This concludes descriptions of at least one embodiment of this disclosure. However, the descriptions of at least one embodiment are not to be read as a restrictive interpretation of the technical scope of this disclosure. At least one embodiment is merely given as an example, and a person skilled in the art would understand that various modifications can be made to at least one embodiment within the scope of this disclosure set forth in the appended claims. The technical scope of this disclosure is to be defined based on the scope of this disclosure set forth in the appended claims and an equivalent scope thereof.

For example, in the above-mentioned at least one embodiment, as an example of editing the two-dimensional image data, there is described an example in which the arrangement of the objects is changed, but the editing processing that can be performed on the two-dimensional image data is not limited to such an example. For example, information (content information or motion information) on a new object may be added to the virtual space data. As a result, two-dimensional image data including an object that was not actually present is obtained as an object to be photographed.

The above-mentioned at least one example may be appropriately switched, or may be appropriately used in combination with other examples. When the position of an object has not changed from an initial position, the recording data does not include the position information on the object in at least one embodiment.

Each process described as being executed by the processor 210 of the HMD set 110 in at least one embodiment may be executed not by the processor 210 of the HMD set 110, but by a processor included in the server 600 or in a distributed manner by the processor 210 and the server 600.

In at least one embodiment, the description is given by exemplifying the virtual space (VR space) in which the user 5 is immersed through use of the HMD 120. However, a see-through HMD device may be adopted as the HMD 120. In this case, the user 5 may be provided with a virtual experience in an augmented reality (AR) space or a mixed reality (MR) space through output of a field-of-view image that is a combination of the real space visually recognized by the user 5 via the see-through HMD device and a portion of an image forming the virtual space. In this case, an action may be exerted on a target object (e.g., display object D) in the virtual space based on a motion of a hand of the user 5 instead of the operation object (e.g., hand object H). Specifically, the processor 210 may identify coordinate information on the position of the hand of the user 5 in the real space, and define the position of the target object in the virtual space 11 based on the relationship with the coordinate information in the real space. With this, the processor 210 can grasp the positional relationship between the hand of the user 5 in the real space and the target object in the virtual space 11, and execute processing corresponding to, for example, the above-mentioned hit determination between the hand of the user 5 and the target object. As a result, an action is exerted on the target object based on a motion of the hand of the user 5.

The subject matters described herein are described as, for example, the following items.

### (Item 1)

An information processing method to be executed by a computer (computer 200 or computer included in server 600) in order to provide a virtual experience to a user 5 via a user terminal (HMD 120) including a display (monitor 130). The method includes generating virtual space data defining a virtual space 11 for providing the virtual experience (Step S1501 of FIG. 15). The method further includes generating a field-of-view image based on a motion of the user terminal and the virtual space data, and displaying the field-of-view image on the display (Step S1510 of FIG. 15). The method further includes storing, based on the virtual space data, recording data for playing back an omnidirectional moving image, which is a video in all directions from a designated position in the virtual space 11 in a predetermined photographing period (Step S1837 of FIG. 18, Step S1944 of FIG. 19, and Step S2254 of FIG. 22). The recording data including content information for defining the virtual space 11 and motion information indicating a motion of a deformable object, which is deformable in accordance with an action by the user 5.

With the information processing method of this item, the user 5 is provided with an experience of looking back at a past virtual experience (state of the virtual space 11 in a past predetermined period) in the virtual space 11. As a result, the entertainment value of the virtual experience of the user 5 can be improved.

### (Item 2)

The information processing method according to Item 1, further including playing back the omnidirectional moving image in the virtual space based on the recording data (Step S1838 of FIG. 18, Step S1945 of FIG. 19, and Step S2255 of FIG. 22). The playing back of the omnidirectional moving image includes identifying the virtual space 11 in the photographing period based on the content information and the motion information, and generating the omnidirectional moving image, which is a video in all directions, from a predetermined viewpoint position in the identified virtual space 11.

With the information processing method of this item, the omnidirectional moving image from the predetermined viewpoint position can be played back in the virtual space 11.

### (Item 3)

The information processing method according to Item 2, wherein the content information includes background image data prescribing a background of the virtual space 11 and definition information on each object. The information processing method further includes identifying the motion of the deformable object in the omnidirectional moving image based on the definition information on the deformable object included in the content information and the motion information on the deformable object, and generating the omnidirectional moving image based on the identified motion of the deformable object and the background image data.

With the information processing method of this item, when an omnidirectional moving image is generated is obtained by photographing the virtual space 11 in the photographing period, the motion (e.g., shape and posture) of the deformable object is based on the definition information and motion information on the deformable object.

### (Item 4)

The information processing method according to Item 2 or 3, wherein the field-of-view image is generated based on a position and an inclination of a virtual camera 14 in the virtual space 11, which are determined in accordance with the motion of the user terminal. The position of the virtual camera 14 is set as the viewpoint position.

With the information processing method of this item, by moving in the virtual space 11 at the present time, the user 5 can enjoy changes in the scenery as if he or she were moving in the same manner in a past virtual space 11 via the omnidirectional moving image that is played back on the virtual screen.

### (Item 5)

The information processing method according to any one of Items 1 to 4, wherein the motion information includes information indicating positions of a plurality of parts P determined in advance of the deformable object.

With the information processing method of this item, the data amount of the motion information can be suppressed.

### (Item 6)

The information processing method according to any one of Items 1 to 5, further includes receiving viewpoint information in the virtual space 11 from the user 5 (Step S2361 of FIG. 23). The method further includes extracting, of the virtual space in the photographing period identified based on the recording data, a portion identified based on the viewpoint information as two-dimensional image data (Step S2364 of FIG. 23).

With the information processing method of this item, a virtual experience is provided in which two-dimensional image data is extracted from any viewpoint position in a recorded virtual space 11 (virtual space 11 in the photographing period), which enables the virtual experience of the user 5 to be richer.

### (Item 7)

The information processing method according to Item 6, further includes receiving from the user 5 editing information for redefining the recording data (Step S2365 of FIG. 23). The method further includes extracting, of the virtual space in the photographing period identified based on the recording data and the editing data, a portion identified based on the viewpoint information as the two-dimensional image data (Step S2366 of FIG. 23).

With the information processing method of this item, the user 5 is provided with a function of generating two-dimensional image data having a composition desired by the user 5.

### (Item 8)

The information processing method according to any one of Items 1 to 7, further including setting a reference position RP in the virtual space 11 (S1941 of FIG. 19). The storing of the recording data includes storing video data obtained by recording a video in all directions from the reference position RP for the photographing period as the recording data.

With the information processing method of this item, similarly to photography by a 360-degree camera in real space, video data centered about the reference position RP in the virtual space 11 can be stored as the recording data.

### (Item 9)

The information processing method according to Item 8, wherein the reference position RP is set based on a mode selected by the user 5 from a plurality of modes prepared in advance. The mode includes information indicating a rule that serves as a reference when a movement pattern of the reference position RP is determined.

With the information processing method of this item, video data is acquired as if photographed while a virtual photographer has moved along a route based on the movement pattern.

### (Item 10)

The information processing method according to Item 9, wherein the plurality of modes include a mode corresponding to a movement pattern for moving the reference position RP such that a character object (avatar) associated with a user 5 having a large quantity of utterances is preferentially shown.

With the information processing method of this item, the user 5 is provided with a mode for preferentially showing an exciting place in the virtual space 11.

### (Item 11)

The information processing method according to Item 9 or 10, wherein the computer is configured to store a determination model. The determination model is generated based on the mode selected by each of the plurality of users 5 and attribute information on the each of the plurality of users 5. The mode is identified based on the attribute information on each of the plurality of users 5 associated with the virtual space 11 and the determination model. The reference position RP is set based on the identified mode.

With the information processing method of this item, a mode suitable is automatically selected for the user 5 by, for example, using a determination model generated by machine learning.

### (Item 12)

An apparatus, including at least a memory (memory module 530); and a processor (processor 210) coupled to the memory. The apparatus being configured to execute the information processing method of any one of Items 1 to 11 under control of the processor.

1-5. (canceled)

6. A method, comprising:
defining a virtual space, wherein the virtual space comprises a virtual viewpoint, a reference position, a first character object associated with a first user, and a second character object associated with a second user;
defining a movement pattern of the reference position in the virtual space and a photography mode, wherein the photography mode comprises a mode selected by the first user from among a plurality of modes;
storing video data captured from the reference position in accordance with the photography mode, wherein the video data defines an omnidirectional moving image in a predetermined photographing period; and
reproducing the stored video data in the virtual space.

7. The method according to claim 6, wherein the defining of the movement pattern is based on the photography mode.

8. The method according to claim 6, wherein defining the movement pattern comprises capturing the video data from the reference position such that a character object of interest of the first character object or the second character object is captured during a majority of the predetermined photographing period.

9. The method according to claim 8, further comprising:
causing the first character object to speak based a first quantity of received sound input from the first user;
causing the second character object to speak based on a second quantity of received sound input from the second user;
establishing the first character object as the character object of interest in response to the first quantity being greater than the second quantity; and
establishing the second character object as the character object of interest in response to the second quantity being greater than the second quantity.

10. The method according to claim 6, further comprising defining a determination model, wherein the determination model is defined based on attribute information on the first user, and the photography mode is identified based on the mode selected by the first user and the determination model.

11. The method according to claim 6, wherein the virtual space is defined based on content information, and the content information comprises:
panorama image data prescribing a background of the virtual space; and
object definition data, wherein the object definition data defines an appearance and a motion of the first character object, the second character object, and a deformable object, and the deformable object is deformable in accordance with an action by the first character object.

12. The method according to claim 11, wherein the deformable object comprises joint information indicating a position of each of a plurality of parts of the first character object, the content information comprises motion information, the motion information is associated with the joint information, and a motion of the deformable object is defined based on the motion information.

13. The method according to claim 12, further comprising:
storing editing information defining an action on the deformable object by the first character object; and
redefining the motion of the deformable object based on the editing information.

14. The method according to claim 6, wherein the defining the movement pattern comprises following the virtual viewpoint during the predetermined photographing period.

15. The method according to claim 6, wherein the defining the movement pattern comprises maintaining the reference point stationary between the first character object and the second character object.

16. The method according to claim 6, wherein the defining the movement pattern comprises following a predetermined movement path in the virtual space.

17. The method according to claim 16, wherein the predetermined movement path encircles at least one of the first character object or the second character object.

18. The method according to claim 6, wherein the reproducing the stored video data comprises reproducing the stored video data as a two-dimensional moving image on a virtual screen of the virtual space, wherein the virtual screen corresponds to an outer periphery of the virtual space.

19. The method according to claim 6, wherein the reproducing the stored video data comprises reproducing the stored video data as a two-dimensional moving image on a display object in the virtual space.

20. A method, comprising:
defining a virtual space, wherein the virtual space comprises a first character object associated with a first user, and a second character object associated with a second user;
moving the first character object in response to a detected movement of the first user;
moving the second character object in response to a detected movement of the second user;
capturing three-dimensional content information of the virtual space during a predetermined photographing period, wherein the three-dimensional content information includes the moving of the first character object and the moving of the second character object;
storing the captured three-dimensional content information; and
reproducing the captured three-dimensional content information in the virtual space.

21. The method according to claim 20, wherein the content information comprises:
panorama image data prescribing a background of the virtual space; and
object definition data, wherein the object definition data defines an appearance and a motion of the first character object, the second character object, and a deformable object, and the deformable object is deformable in accordance with an action by the first character object.

22. The method according to claim 21, wherein the deformable object comprises joint information indicating a position of each of a plurality of parts of the first character object, the content information comprises motion information, the motion information is associated with the joint information, and a motion of the deformable object is defined based on the motion information.

23. The method according to claim 22, further comprising:
storing editing information defining an action on the deformable object by the first character object; and
redefining the motion of the deformable object based on the editing information.

24. An apparatus, comprising:
a non-transitory computer readable medium configured to store instructions thereon; and
a processor connected to the non-transitory computer readable medium, wherein the processor is configured to execute the instructions for:
defining a virtual space, wherein the virtual space comprises a virtual viewpoint, a reference position, a first character object associated with a first user, and a second character object associated with a second user;
defining a movement pattern of the reference position in the virtual space and a photography mode, wherein the photography mode comprises a mode selected by the first user from among a plurality of modes;
storing video data captured from the reference position in accordance with the photography mode, wherein the video data defines an omnidirectional moving image in a predetermined photographing period; and
reproducing the stored video data in the virtual space.

25. The apparatus of claim 24, further comprising a head-mounted display (HMD) connected to the processor, wherein the HMD is configured to display the reproduced stored video data.
